(19) United States
(12) Patent Application Publication
(10) Pub. No.: US 2026/0243228 A1
(43) Pub. Date: Aug. 20, 2026

(54) FLEXIBLE OPERATION AND RECIPROCATING NEAR-ISOTHERMAL GAS COMPRESSOR/EXPANDER FOR WIND ENERGY STORAGE

(71) Applicant: University of Virginia Patent Foundation, Charlottesville, VA (US)

(72) Inventor: Eric Loth, Charlottesville, VA (US)

(21) Appl. No.: 19/441,023

(22) Filed: Jan. 6, 2026

Related U.S. Application Data
(63) Continuation of application No. PCT/US2024/036778, filed on Jul. 3, 2024.
(60) Provisional application No. 63/512,226, filed on Jul. 6, 2023.
(60) Provisional application No. 63/647,957, filed on May 15, 2024.

(51) Int. Cl. F03D 9/25; F03D 9/17; H02K 5/20; H02K 7/075; H02K 7/18

(52) U.S. Cl. CPC F03D 9/25; F03D 9/17; H02K 5/203; H02K 7/075; H02K 7/1838; F05B 2220/706; H02K 2205/09

(57) ABSTRACT

A system for flexible operation for wind energy storage, and a related method, the system including a wind turbine having a rotor disposed thereon, a rotor shaft extending from the rotor and rotatable therewith, an electrical generator disposed in communication with the rotor shaft, a power generation/regeneration system, which may include a fluid power system, is disposed in communication with the rotor shaft, where rotation of the rotor shaft rotates the electrical generator to produce generator power (P_{g}), where, when the fluid power system is in a power generation mode, aerodynamic rotation of the rotor shaft produces fluid power (P_{f}) at the fluid power system, at least a position of which is stored as energy in an energy storage, and where, when the fluid power system is in a power regeneration mode, energy is released from the energy storage and converted by the fluid power system to fluid power (P_{f}) that can be combined with aerodynamic rotor power to drive the electrical generator.

### CROSS REFERENCE TO RELATED APPLICATIONS

This application is related to and claims the benefit of U.S. Provisional Patent Application Nos. 63/512,226 and 63/647,957 filed Jul. 6, 2023 and May 15, 2024, respectively. This application is also related to International Patent Application Number PCT/US2022/044620, filed on Sep. 23, 2022, which claims priority to U.S. Provisional Patent Application Nos. 63/248,124 and 63/305,734, filed on Sep. 24, 2021 and Feb. 2, 2022, respectively. All of the cited applications are herein incorporated by reference in their entirety.

### STATEMENT REGARDING FEDERALLY SPONSORED RESEARCH OR DEVELOPMENT

This disclosure was made with government support under DE-AR0000667 awarded by the U.S. Department of Energy, and 2324460 awarded by the National Science Foundation. The government has certain rights in the disclosure.

### TECHNICAL FIELD

The disclosure generally relates to wind energy technologies and, more particularly, to a flexible operation for wind energy storage, including super-rated operation which allows a rotor to generate excess power beyond that of an electrical generator for a large variety of operational conditions, and to a means of compressed air energy storage, including a reciprocating piston-based near-isothermal air compressor/expander which employs piston-based coupling for pneumatic power take-off and/or regeneration. This turbine operation with energy storage can be highly flexible to accommodate variations in wind resources and energy demand. The tower may be used as an internal storage chamber for pressurized fluid and a tower side casing or multiple tower side casings can be added along with a modified rotor operation to address rotor-tower interference limits. The energy storage can later be regenerated to provide electrical energy. In addition, the power take-off can be converted to other forms of energy including electrolysis to generate hydrogen, to perform water desalination, potential energy by raising/lowering large masses, and rotational kinetic energy to drive a fly wheel.

To facilitate wind energy storage, also disclosed herein is a reciprocating piston-based near-isothermal air compressor/expander which employs piston-based coupling for pneumatic power take-off and/or regeneration. To provide high round-trip efficiency for the fluid power energy storage, the compression and expansion processes are made nearly isothermal by using low rotation speeds and heat exchanger networks combined with a Liquid Layer And Mesh with Mechanical Piston (LLAMMP) approach. Also provided herein are new geometries for a compressible/flexible heat exchanger and/or a spray-based heat exchanger design with the mechanical piston approach.

### BACKGROUND

Wind turbines provide intermittent power and thus may benefit from an integration with energy storage systems. Locally integrating energy storage at the site of wind energy generation can level the resulting energy generation. This reduction in intermittency can provide more value to the grid. Integrated onsite energy storage for wind turbines can capture power that might have been curtailed due to low grid demand as well as excess power beyond the rated electrical power, which would otherwise be lost without energy storage. Capturing curtailed and/or excess power at the wind turbine/farm without increasing the size of the electrical generator can increase the capacity factor of a wind turbine/farm which can reduce relative transmission costs. For example, increasing the wind farm capacity factor by 20% reduces the size/cost of the needed transmission lines by 20% relative to the average energy delivered. This benefit can be especially pronounced when the cost of energy transmission lines is high (due to long distances or complex siting, as in offshore or mountainous locations), when upgrading line capacity for new generation is problematic (due to permitting, safety, and impact issues), and when transmission lines are environmentally/socially invasive. The ability to integrate energy storage and the ability to capture curtailed and/or excess energy are facilitated with the present disclosure which provides flexible operation for wind turbines to store energy. This may allow the net electrical energy delivered to be increased relative to that of a conventional wind turbine while keeping approximately the same size rotor, tower, generator, and transmission lines. This curtailed and/or excess power can be translated to fluid power, or can be used for electrolysis to generate hydrogen, or can be used for water desalination, or be used to raise/lower large masses to store gravitational potential energy, or can be used to drive a fly wheel (within the tower or at the base of the turbine) to store rotational kinetic energy.

Where fluid power is utilized, the energy storage can employ Compressed Air Energy Storage (CAES). However, fluid power compressors and/or expanders for CAES with for wind turbines conventionally include: a) complicated mechanical systems for energy take off and for energy regeneration and b) high roundtrip thermal energy losses due to air temperature changes. Herein, these two problems are addressed as follows:

Reciprocating Pneumatic Power: A reciprocating pneumatic system driven by rotor/generator shaft power is used for gas (air) compression and expansion without the need for intermediary hydraulic power; and

High Thermal Efficiency Near-isothermal processes for the air compressors/expanders are achieved with a novel Liquid Layer And Meshes with Mechanical Piston (LLAMMP) approach to provide high heat transfer during compression and expansion

This LLAMMP concept may have value in other systems where high-efficiency pneumatic power is required.

### BRIEF SUMMARY

The disclosure presents a system for flexible operation for wind energy storage, including a wind turbine having a rotor disposed thereon, a rotor shaft extending from the rotor and rotatable therewith, an electrical generator disposed in communication with the rotor shaft, a power generation/regeneration system, preferably a fluid power system, is disposed in communication with the rotor shaft, where rotation of the rotor shaft rotates the electrical generator to produce generator power (P_{g}), which may include an intermediary gearbox. When the fluid power system is in a power generation mode, rotation of the rotor shaft produces fluid power (P_{f}) at the fluid power system, which may include an intermediary gear ratio, for energy storage, and where, when the fluid power system is in a power regeneration mode, energy is released from the energy storage and converted by the fluid power system to provide fluid power (P_{f}) that rotates the rotor shaft within the electrical generator, which may include an intermediary gear ratio.

In one embodiment, the electrical generator is described as having a maximum power rating (P_{g,rated}), and when the fluid power system is in the power generation mode (sending energy to storage), a total power (Pᵣ) produced by the rotation of the rotor is used for the generator power (P_{g}) combined with the fluid power (P_{f}), where the total power of the rotor (Pᵣ) may be greater than the maximum power rating (P_{g,rated}) of the electrical generator when the rotor is rotated at or above a minimum wind speed for rated electrical power production (U_{rated}), while limiting the rotor thrust and rotor rotation rate to be approximately equal to or less than their conventional rated values.

In another embodiment, the generator power (P_{g}) is equivalent to the maximum power rating (P_{g,rated}) at and above the minimum wind speed for rated power production (U_{rated}).

In still another embodiment, the generator power (P_{g}) is less than the maximum power rating (P_{g,rated}) at the minimum wind speed for rated power production (U_{rated}) to allow power to be curtailed and/or to allow power to be sent to a fluid power system or to a flywheel system or to a hydrolysis system or to a water desalination system.

A further embodiment, the fluid power system is configured to be operated at 0% of the maximum power rating (P_{f,rated}), or at a fraction of the maximum power rating (P_{f,rated}) at the minimum wind speed for rated power production (U_{rated}), or at 100% of the maximum power rating (P_{f,rated}).

In one embodiment of the system, when the fluid power system is in the power regeneration mode (using stored fluid energy), the power (Pᵣ) produced by the rotation of the rotor combined with the fluid power (P_{f}) is used to provide the electrical generator power (P_{g}), which may reach the maximum power rating (P_{g,rated}).

A further embodiment includes a tower having an interior volume and a tower side casing disposed on an exterior of the tower, where some components of the wind turbine (electrical connections, access connections) are disposed in and/or extend through the tower side casing or multiple tower side casings, and where the energy storage is disposed in at least part of the internal volume of the tower.

The energy storage power generation/regeneration system is described as including at least one of a fluid power system, a gravitational potential energy system, a rotational kinetic energy system including a flywheel disposed in a tower or a base of the wind turbine.

In a further embodiment, the excess and/or curtailed energy may be used to power a hydrolysis system to produce hydrogen or to power a water desalination system to produce fresh water.

In a particular embodiment, the power generation/regeneration system is a fluid power system including a piston-based air compressor/expander having a plurality of pistons coupled to a crankshaft whereby rotation of the crankshaft drives the pistons in a reciprocating manner, where the crankshaft is directly connected to the rotor shaft such that crankshaft and the rotor shaft rotate at the same speed, or the crankshaft is connected to the rotor shaft by a geared mechanism such that the crankshaft and the rotor rotate at different speeds, where the electrical generator is directly connected to the rotor shaft such that electrical generator and the rotor shaft rotate at the same speed, or the electrical generator is connected to the rotor shaft or to the crankshaft by a geared mechanism such that the electrical generator and the rotor shaft or crankshaft, respectively, rotate at different speeds.

In a further embodiment, the air compressor/expander, the rotor shaft, the gear mechanism, and the electrical generator are disposed in a nacelle, though the compressor/expander may also be disposed in a front frame and/or nosecone and/or tower and/or adjacent to the generator.

In a further embodiment, one or more of the cylinder casings for the compressor/expander is within the tower and supported by the tower shell where the shell can provide good thermal conductivity as well as structural support for the elevated air pressures.

In a further embodiment, an air duct inlet located on the exterior of the nacelle or the nose cone is configured to entrain the ambient air from a wind stream directed at the wind turbine, to flow this air over the compressor/expander surfaces for convective heat transfer, and to exhaust this air to the exterior of the nacelle.

In a further embodiment, the piston-based air compressor/expander may be partially or fully disposed to be exterior to the nacelle so that air from a wind stream directed at the wind turbine can pass over the compressor/expander surfaces for convective heat transfer.

Still further, the compressor/expander cylinder chambers disclosed for a single-stage system or for the final stage (highest pressure) of a multiple-stage system will have at least one storage valve that can be used for directing air which is compressed by the piston into the energy storage during compression and/or may also be used for extracting air from energy storage to the chamber where it can be expanded by the piston during expansion.

Still further, the compressor/expander cylinder chambers disclosed for a non-final stage of a multiple-stage system will have at least one higher-stage valve that can be used for directing air which is compressed by a non-final stage into a flow line that feeds to the next (higher pressure) stage system during compression and/or may also be used for extracting air from the next (higher pressure) stage system to the non-final stage chamber where it can be expanded by the piston during expansion.

Still further, the compressor/expander cylinder chambers disclosed for a single-stage system or the first stage (lowest pressure) of a multiple stage system will have at least one ambient valve that can be used for drawing air into the piston chamber from the ambient environment for compression and/or may also be used for exhausting air from the piston chamber into the ambient environment after expansion.

Still further, the compressor/expander cylinder chambers disclosed for a non-first stage of a multiple-stage system will have at least one lower-stage valve that can be used for drawing air into the piston chamber from a lower stage system for compression and/or may also be used for exhausting air from the piston chamber after expansion to the lower-stage system.

Still further, the flow connection between successive stages of a multiple-stage compressor/expander system can include intermediate settling chambers to enable intermediary heat transfer and reduce pressure fluctuations between stages.

Still further, the intermediate settling chambers between stages of a multiple-stage compressor/expander system may take advantage of a portion or all of the wind turbine tower to help form this pressurized settling chamber.

In a further embodiment, the compressor/expander cylinder chambers may have an emergency relief valve for releasing compressed air from the piston on demand and may have a liquid jacket disposed on a casing of a cylinder of the piston configured to provide convective heat transfer between the casing and the ambient environment to help provide near isothermal conditions.

In one illustrative embodiment, the plurality of pistons includes a cylinder, a piston head disposed movably in the cylinder, a cylinder volume within the cylinder that varies upon movement of the piston head, where the cylinder volume contains a liquid volume, a gas volume, and porous heat transfer surfaces and where a coned, curved, or slanted cylinder head may be used to reduce dead volume and structural loads and can be configured to provide a squish flow.

In another example, the porous heat transfer surfaces to help provide near isothermal conditions are disposed at an upper region of the cylinder volume adjacent to the storage and ambient valves, the porous heat transfer surfaces being configured to allow the gas and liquid to pass therethrough during compression and expansion of the cylinder volume upon movement of the piston head and to provide convective heat transfer between the gas, liquid, a casing of the cylinder, and the ambient environment.

The porous heat transfer surfaces to help provide near isothermal conditions are described illustratively as horizontal, vertical, or angled porous layers, or other porous geometries and including one or more of the following: fixed heat transfer elements secured immovably within the cylinder volume, movable heat transfer elements that expand and compress within the cylinder volume during movement of the piston head by way of bellows, spring coils, and/or axial cables, and heat transfer elements formed of wire mesh, perforated plates, honeycomb structures, bio-inspired mesh, or stackable mating plates.

A further version of the disclosed system to help provide near isothermal conditions includes at least one nozzle disposed in the cylinder volume proximate to spray liquid into the gas volume below the porous heat transfer surfaces to provide heat transfer.

Still further, the compressor/expander cylinder chambers may employ at least one drain valve to remove liquid from the chamber.

### BRIEF DESCRIPTION OF THE DRAWINGS

For a more complete understanding of this disclosure, reference is now made to the following brief description, taken in connection with the accompanying drawings and detailed description, wherein like reference numerals represent like parts, in which:

FIG. 1 Conventional Operation (CO) of electrical generator power (P_{g}) vs. wind speed (U) where rated electrical generator power (P_{g,rated}) occurs at the rated wind speed (U_{rated}).

FIG. 2 Conventional Operation (CO) of rotor rotation rate (ωᵣ) vs. wind speed (U) where rated rotor rotational speed (ω_{r,rated}) occurs at the rated wind speed (U_{rated}).

FIG. 3 Power variation with wind speed for “Storage with Maximum Generator Power” (SMGP) where generator power (P_{g}) is capped at the rated generator power (P_{g,rated}) limit as in CO (also shown) but the rotor produces additional power at wind speeds beyond the rated wind speed in the form of fluid power (P_{f}), which is capped at the rated fluid power (P_{f,rated}).

FIG. 4 Rotor thrust variation with wind speed for SMGP where rotor thrust is the same as CO (also shown) for U<U_{rated} but rotor rated thrust (T_{rated}) for SMGP is nearly constant for U_{rated}<U<U_{cap} and then decreases for U_{cap}<U<U_{cut-out}.

FIG. 5 Power variation with wind speed for “Storage with Maximum Fluid Power” (SMFP) where the rotor power is the same as in FIG. 3 but the fluid power is maximized at all wind speeds, which reduces the generator power in Regions 2 and 3⁺ relative to that for CO.

FIG. 6 Power variation with wind speed for “Storage with Discrete Fluid Power” (SDFP), which allows fluid power to change in discrete amounts as wind speed changes.

FIG. 7 Power variation with wind speed for “Storage with Only Fluid Power” (SOFP) to maximize energy storage while employing complete generator power curtailment.

FIG. 8 Power variation with wind speed for “Regeneration with Maximum Fluid Power” (RMFP) which maximizes regenerated fluid power delivered to the electrical generator, where this maximum fluid power is achieved by regenerating at the rated fluid power rotation rate for all wind speeds.

FIG. 9 Power variation with wind speed for “Continuous Regeneration with Conventional Rotor Power” (CRCRP), which employs conventional rotor power but adds regenerated fluid power for wind speeds between U_{cut-in} and U_{rated} to increase power delivered to the electrical generator, where this fluid power increases with wind speed between U_{cut-in} and U_{rated} due to changes in shaft speed with wind speed as in FIG. 2.

FIG. 10 Power variation with wind speed for “Discrete Regeneration with Conventional Rotor Power” (DRCRP), which is the same as CRCRP, except that the fluid power changes discretely with wind speed in Region 2^{f} (between U_{f} and U_{rated}).

FIG. 11A-B Horizontal cross-section of the tower for a conventional upwind wind turbine and for a wind turbine with a tower side casing along the tower.

FIG. 12A-B Vertical cross-section of the tower for a conventional upwind wind turbine and a wind turbine with added tower side casing along the entire tower as in FIG. 11 (the tower diameter is exaggerated and assumed constant to simplify description).

FIG. 13 Vertical cross-section of the tower as in FIG. 12A-B but for a partial tower side casing, which extends over only a portion of the tower.

FIG. 14A-B A conventional onshore wind turbine with gravitational foundation and a wind turbine with flywheel in the foundation to store kinetic energy.

FIG. 15A-B Side view of a wind turbine where the rotor (only the inner portion shown) is connected by a shared shaft to a direct-drive electrical generator and then to a piston-based compressor/expander (where the cylinders may be tilted from the vertical if the rotor/shaft is tilted from the horizon) for: a) direct-drive compressor/expander such that it will have the same rotation rate as the rotor, and b) geared-drive compressor/expander such that it will have a higher rotation rate than the rotor.

FIG. 16 Same as in FIG. 15A except that a gearbox (placed after the compressor/expander) is added to drive a high-speed shaft for the electrical generator.

FIG. 17 Same as in FIG. 16 except that the compressor/expander is placed aft side of the generator gearbox where the compressor/expander can have the same rotation rate as the rotor or can have a higher rotation rate than the rotor.

FIG. 18 Schematic as in FIG. 15A but showing a nacelle that includes an internal air duct to provide convective cooling to compressor/expander pistons.

FIG. 19A-B Side- and rear-view cross-sections of a cylinder with piston, storage valve(s), ambient valve(s), and emergency pressure-relief valve(s), where side view shows potential rotor/shaft/piston side tilt.

FIG. 20A-B Side- and rear-view cross-sections as in FIG. 19 but with inclusion of a liquid jacket for heat transfer.

FIG. 21A-C Rear-view cross-section of a cylinder with the Liquid Layer And Mesh with Mechanical Piston (LLAMMP) approach for a flat cylinder head and fixed layers of heat exchanger surfaces for times when the piston is located: a) at Bottom Dead Center (where the heat exchanger layers are fully exposed to the gas), b) just after completing compression or just before expansion (where the heat exchanger layers may be partially-submerged) and c) at Top Dead Center (where the heat exchanger layers are fully-submerged in the liquid).

FIG. 22A-B Side view cross-sections of a cylinder (which can include side tilt) with the LLAMMP approach when piston is at Top Dead Center and a liquid drain valve is near the bottom of the chamber volume while cylinder valves are near the top of the chamber volume on the cylinder head where the cylinder head can have a shape that is: a) coned or b) rounded.

FIG. 23A-C Schematic cross-sections of a cylinder from with fixed heat exchanger layers and the LLAMMP approach for piston position just before completing compression or just after expansion where geometry includes a squish regions shown from: a) rear view (so side tilt is not shown), b) top view for a mesh-based heat exchanger surface, c) top view for a mesh-based heat exchanger surface with internal structural supports.

FIG. 24A-B Wire mesh layer viewed from above showing: a) a multitude of mesh pores and b) a close-up showing wire diameter (d_{wire}) and wire mesh spacing (L_{wire}) for a single pore.

FIG. 25A-C Example porous layer heat exchanger geometries including perforated plate, perforated honeycomb design, and a bio-inspired network which uses series of successively smaller heat transfer elements.

FIG. 26A-C Rear view cross-sections of a cylinder as in FIG. 21 but with the addition of axially-collapsible heat transfer layers in the lower gas volume.

FIG. 27A-D Examples of axially-collapsible porous heat transfer layers which include layers connected by bellows, by cables, and by helical springs.

FIGS. 28A-B Schematic cross-section of stackable mating plates for axially-collapsible heat transfer surfaces, showing plates before collapsing and after collapsing.

FIGS. 29A-C Rear view cross-sections of a cylinder as in FIG. 21 but with the addition of spray-based system in the lower gas volume of the chamber.

### DETAILED DESCRIPTION

### 1.1 Overview of Conventional Wind Turbine Operation

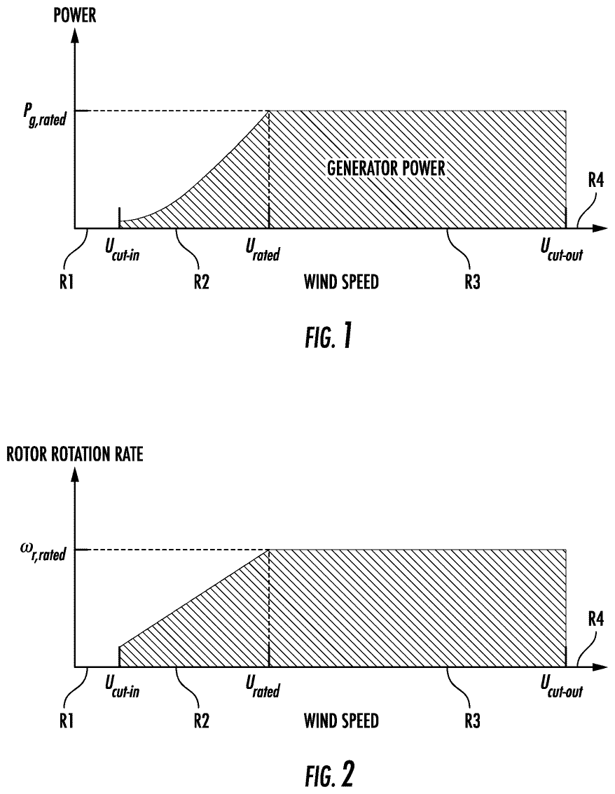

Conventional Operation (CO) of a wind turbine is discussed with reference to FIGS. 1-2 whereby the mechanical power produced by the rotor (Pᵣ) is directly converted to electrical power by the electrical generator (P_{g}). Neglecting the small power losses from the rotor to the generator (which are typically limited to a few percent), the rotor power and generator power are approximately equal (Pᵣ=P_{g}) for CO. In general, the available rotor power that can be produced is proportional to the cube of the wind speed (U³). However, the electrical generator typically has a maximum electrical power limit, which is denoted as the generator rated power (P_{g,rated}). Therefore, the rotor power is typically controlled to avoid generating more power than the rated power of the electrical generator. Furthermore, the rotor cannot operate safely if the wind speed is too high and cannot operate effectively if the wind speed is too low. As such, conventional wind turbine operation is characterized by three reference wind speeds:
Cut-in wind speed (U_{cut-in}), which is the minimum wind speed for conventional power production
Rated wind speed (U_{rated}), which is the minimum wind speed for rated electrical power production
Cut-out wind speed (U_{cut-in}), which is the maximum wind speed for electrical power production.
   Neglecting power losses between the rotor and the generator, these three reference speeds can be used to describe Conventional Operation (CO) with four operational regimes (Regions 1-4) where each is described by a wind speed range with the corresponding rotor power (Pᵣ) relative to rated generator power P_{g,rated}) and the corresponding rotor angular speed (ω) relative to its value at rated wind speed (ω_{rated}) as follows:

| | | | |
|---|---|---|---|
| Region 1 | U < U_{cut-in} | Pᵣ = 0 | ω ~ 0 |
| Region 2 | U_{cut-in} < U < U_{rated} | Pᵣ = P_{g, rated} (U/ U_{rated})³ | ωᵣ = ω_{r, rated} (U/U_{rated}) |
| Region 3 | U_{rated} < U < U_{cut-out} | Pᵣ = P_{g, rated} | ωᵣ = ω_{r, rated} |
| Region 4 | U > U_{cut-out} | Pᵣ = 0 | ωᵣ ~ 0 |

These four regions are shown in FIG. 1 in terms of power and in FIG. 2 in terms of rotation rate. Each of these regions are discussed in the following.

In Region 1 (U<U_{cut-in}), the wind speeds are too low for effective power production, so the turbine is parked with little or no rotation (ωᵣ~0). In Region 2 (U_{cut-in}<U<U_{rated}), the turbine aims to extract maximum available rotor power, and the available rotor power approximately increases with the cube of the wind speed, i.e. Pᵣ~U³ as shown in FIG. 1. Also in Region 2, the rotor angular speed (ω) increases approximately linearly with wind speed, such that the Tip Speed Ratio (TSR) is kept near the ideal value to maximize power extraction from the wind, as shown in FIG. 2. The minimum wind velocity for which electrical power reaches the rated power (P_{g}=P_{g,rated}) is the rated wind speed (U_{rated}). As the wind speed increases further, the turbine enters Region 3 for which the wind turbine power and rotor RPM are kept nearly constant (as shown in FIGS. 1 and 2) via a control system. This control is typically achieved using blade pitch and/or generator torque control. In Region 3, the rotor spins at the rated rotation rate (ω_{r,rated}), where this limit may be based on structural loads, flutter, noise, etc. Finally, Region 4 occurs when the wind speed exceeds the cut-out wind speed (U>U_{cut-out}) which represents wind speeds above the limit for safe operation, for which the rotor is parked so the rotor RPM is nominally zero and the rotor and electrical generator power are also zero.

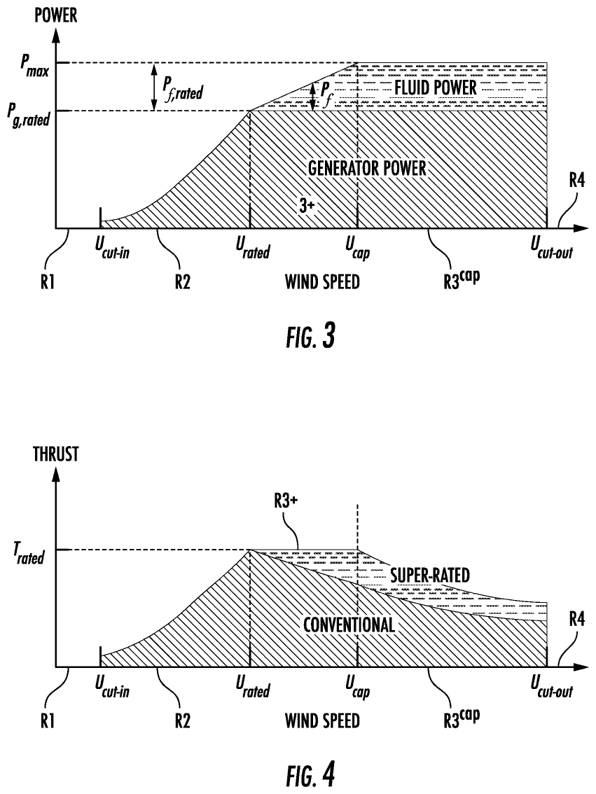

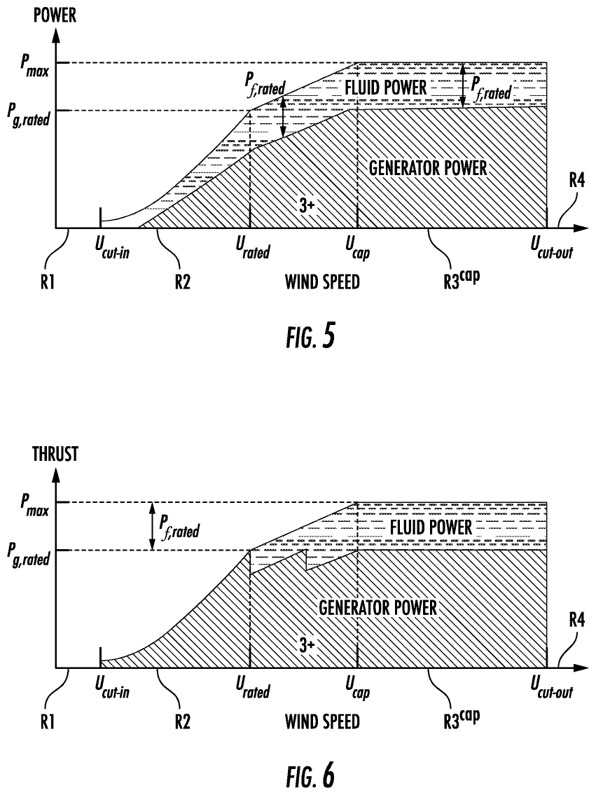

The quasi-steady rotor aerodynamic thrust (T) for CO equals the rated thrust (T_{rated}) at the rated wind speed (U_{rated}), and otherwise is generally proportional to the ratio of rotor power to the wind speed. See, e.g., FIG. 4. As such, the thrust in Region 2 tends to increase with square of the wind speed (is proportional to U²) and the thrust in Region 3 tends to decrease inversely with wind speed (is proportional to 1/U). The thrust is nominally zero for Regions 1 and 2, since rotor power is zero for Regions 1 and 2.

The above region descriptions represent the main regions but do not include intermediate regions often used with conventional wind turbines, such as Region 1.5, Region 2.5 and curtailment (Tian et al. 2023). Near the cut-in wind speed, Region 1.5 is often included in turbine control to allow for higher rotation rates at lower wind speeds (higher TSR than ideal) to be help avoid excessively small operational rotation speeds for the electrical generator. Near the rated wind speed, Region 2.5 is often included in turbine control to provide a smooth transition in system dynamics and performance between Regions 2 and 3. This Region 2.5 may include a nearly constant thrust combined with constant rotation rate. This nearly constant thrust (accomplished by reducing the axial induction factor near the rated wind speed) helps limit the peak bending moments on the blades and on the tower near U_{rated}. In addition, curtailment may occur if available wind energy is excessive relative to grid demand (which can be reflected by energy prices that are very low or negative). In these cases, rotor and generator power in between U_{cut-in}<U<U_{cut-out} will be reduced or set to zero. For simplicity, we will ignore the nuances of Regions 1.5 and 2.5 in the following operational descriptions, but the curtailment option will be included.

1.2 Flexible Wind Turbine Operation with Fluid Energy Storage

In general, energy storage is typically preferred when energy prices are below average (while regeneration is typically preferred when energy prices are above average, as discussed Section 1.3). The fluid power (P_{f}) can be sent and received from energy storage, and the maximum power for the fluid power system is the rated fluid power (P_{f,rated}). This is established based upon limitations, mechanical or otherwise, inherent in the fluid power system. Energy storage may also have a maximum energy capacity of the storage system. During storage, fluid power taken from the rotor power and sent to storage is defined herein as a positive value so the total power produced by the rotor during storage is the sum of the generator and fluid power systems, i.e. Pᵣ=P_{g}+P_{f}.

Herein, the rotor power, the fluid power and the electrical power are all allowed to flexibly vary depending on wind speed, grid energy demand, and storage capacity. This will give rise to several storage operational schemes based on energy demand and storage capacity, each with multiple wind speed regions. There are five specific schemes of wind turbine operation with energy storage that can be employed:
Storage with Maximum Generator Power (SMGP)
Storage with Maximum Fluid Power (SMFP)
Storage with Discrete Fluid Power (SDFP)
Storage with Only Fluid Power (SOFP)
Storage with Conventional Rotor Power (SCRP)
   The following describes these different schemes, while also considering operations that are intermediate to these limits.
   1.2.1 Storage with Maximum Generator Power

First, the Storage with Maximum Generator Power (SMGP) super-rated scheme is defined as that which prioritizes and maximizes electrical power and then uses any excess available rotor power for fluid power. As shown in FIG. 3, the generator power (P_{g}) for SMGP has the same dependence on wind speed as in Conventional operation (CO) for Regions 1, 2, 3, and 4 (as previously described with reference to FIG. 1). In addition, the rotor rotation rate in SMGP operates the same as in Conventional operation (CO) for Regions 1, 2, and 4 (as previously described with respect to FIG. 2). However, the conventional Region 3 rotor operation is replaced with two new regions for SMGP: Region 3⁺ and Region 3^{cap}, where both regions have a constant rotor speed limited by ω_{r,rated}. However, Region 3⁺ allows for increasing rotor power with wind speed while Region 3^{cap} limits the rotor power to a constant.

Region 3⁺ for SMGP occurs for a wind speed range of U_{rated}<U<U_{cap} for which the rotor power increases nearly linearly with wind speed. This linear increase of power with wind speed is designed to provide nearly constant rotor thrust in Region 3⁺ (since thrust is proportional to the ratio of rotor power and wind speed per inviscid actuator disc theory). For comparison, FIG. 4 also shows the rotor aerodynamic thrust for a conventional wind turbine, where the thrust increases with wind speed for Region 2 (U_{cut-in}<U<U_{rated}) but decreases as wind speed increases for Region 3 (U_{rated}<U<U_{cut-out}). Operating at a nearly constant rotor thrust for Region 3⁺ (as shown in FIG. 4) is desirable since it limits the steady-state downwind tower and blade moments. Minimizing these moments reduces costs associated with the structure of the blades, the tower structure, and the turbine foundation and/or substructure. As such, Region 3⁺ super-rated operation allows for extra rotor power production relative to CO while avoiding an increase in the peak thrust generation relative to CO.

When the wind speed for SMGP is high enough that the resulting fluid power reaches the rated fluid power (P_{f,rated}), this wind speed is designated as the capped wind speed (U_{cap}) for which further increases in wind speed will lead to Region 3^{cap}, i.e., Region 3^{cap} occurs for U_{cap}<U<U_{cut-out}. In Region 3^{cap}, the fluid and generator systems are both limited to their rated powers (P_{f,rated}, P_{g,rated}) so the rotor power maximized and is the sum of these two rated powers (Pₘₐₓ=P_{g,rated}+P_{f,rated}). For the wind speeds associated with Region 3^{cap}, the constant rotor power coupled with increasing wind speed results in a decrease in aerodynamic rotor thrust as wind speeds increase as shown in FIG. 4. This reduction in thrust for Region 3^{cap} reduces moments on the blades, the tower and the foundation and/or substructure.

Based on the above description of SMGP super-rated operational scheme, the rotor power and rotation rate vary with wind speed as:

| | | | |
|---|---|---|---|
| Region 1 | U < U_{cut-in} | Pᵣ = 0 | ωᵣ ~ 0 |
| Region 2 | U_{cut-in} < U < U_{rated} | Pᵣ = P_{g, rated} (U/U_{rated})³ | ωᵣ = ωᵣ (U/U_{rated}) |
| Region 3⁺ | U_{rated} < U < U_{cap} | Pᵣ = P_{g, rated} (U/U_{rated}) | ωᵣ = ω_{r, rated} |
| Region 3^{cap} | U_{cap} < U < U_{cut-out} | Pᵣ = P_{g, rated} + P_{f, rated} | ωᵣ = ω_{, rated} |
| Region 4 | U > U_{cut-out} | Pᵣ = 0 | ωᵣ ~ 0 |

To achieve this super-rated SMGP rotor power distribution, the rotor blade pitch can be varied as a function of blade speed and wind speed. This super-rated blade pitch in Regions 3⁺ and 3^{cap} will generally be less than the conventional Region 3 blade pitch since more power is being extracted by the rotor during super-rated operation (Simpson et al. 2022). However, the rotor rotation rate for this super-rated scheme is the same as that seen for a conventional wind turbine (FIG. 2). Limiting the rotor speed in both Regions 3⁺ and 3^{cap} to be the same as the conventional rotor rated speed is helpful to prevent blade flutter, excessive rotor acoustics (noise), and high-frequency tower excitation that could occur at higher rotor rotation speeds.

Since the maximum generator power, maximum rotor thrust, and maximum rotor speed are the same for both conventional operation and SMGP operation, the blades, tower, foundation and/or substructure may not need significantly redesign for a super-rated system. Furthermore, platform stability for a floating turbine can be enhanced by having a nearly constant thrust for Region 3⁺ (U_{rated}<U<U_{cap}). However, the SMGP peak thrust levels occur at higher wind speeds so the unsteady loads (due to turbulence and structure dynamics) will generally be higher than for CO. This may require changes to the rotor and/or tower structural load designs to handle higher unsteady peak loads and higher fatigue loads. In addition, the increased power supplied by the rotor in Regions 3⁺ and 3^{cap} yields an increased maximum rotor torque (compared to that for a conventional turbine). This increased maximum torque may require enhanced structural design for blades, hub, and bearings.

1.2.2 Storage with Maximum Fluid Power

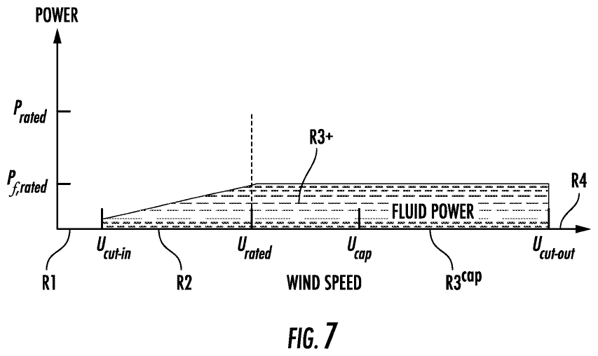

While the SMGP super-rated scheme maximizes electrical power generation for all wind speeds, this may not be ideal when the instantaneous (e.g., hourly) energy prices are below average since it may be better to have more energy storage at these times (in order to regenerate more energy later when energy prices are higher). To address such conditions, a super-rated scheme can be employed whereby the fluid power (instead of electrical power) is prioritized and maximized. This scheme is termed Storage with Maximum Fluid Power (SMFP) and maximizes energy storage at all operational wind speeds as shown in FIG. 5.

For SMFP, the rotor speed variation with wind speed is the same as in CO (as shown in FIG. 2) while the rotor power is the same as for SMGP (as shown in FIG. 3). However, fluid power for energy storage with SMFP is maximized in Regions 2, 3⁺ and 3^{cap} so the generator power is accordingly reduced (relative to CO) in Regions 2 and 3⁺. In particular, the SMFP generator power is the remainder between the rotor power and the fluid power (P_{g}=Pᵣ−P_{f}). The generator power and rotor speed for SMFP can be expressed as

| | | | |
|---|---|---|---|
| Region 1 | U < U_{cut-in} | P_{g} = 0 | ω ~ 0 |
| Region 2 | U_{cut-in} < U < U_{rated} | P_{g} = P_{g, rated} (U/U_{rated})³ − P_{f} | ωᵣ = ω_{r, rated} (U/U_{rated}) |
| Region 3⁺ | U_{rated} < U < U_{cap} | P_{g} = P_{g, rated} (U/U_{rated}) − P_{f, rated} | ωᵣ = ω_{r, rated} |
| Region 3^{cap} | U_{cap} < U < U_{cut-out} | P_{g} = P_{g, rated} | ωᵣ = ω_{r, rated} |
| Region 4 | U > U_{cut-out} | P_{g} = 0 | ωᵣ ~ 0 |

For Regions 3⁺ and 3^{cap} of SMFP, the extracted fluid power is based on the rated fluid power (P_{f,rated}) and the rotor speed is set at the rated value (ω_{r,rated}). In Region 3^{cap} of SMFP, the available total power is constant so fluid and generator powers are equal to their rated powers (P_{f}=P_{f,rated} and P_{f}=P_{g,rated}), which is the same as for SMGP. In Region 3⁺, available total power decreases as wind speed decreases based on nearly constant thrust for this wind speed range, so the thrust for SMFP has the same trend as for SMGP (FIG. 4). However, the fluid power for SMFP in Region 3⁺ is equal to its rated power (P_{f}=P_{f,rated}) so the SMFP generator power (P_{g}) decreases as wind speed decreases due to reduced available total power.

In Region 2, the maximum fluid power with SMFP may reduce as wind speed decreases as shown in FIG. 5. To explain this, we first note that the rotor rotation rate decreases linearly as wind speed decreases, i.e. ωᵣ=ω_{r,rated} (U/U_{rated}) in Region 2 (per FIG. 2). If the fluid power and rotor are on the same shaft (ω_{f}=ωᵣ) or if the fluid power and rotor are connected via a gearbox with a fixed speed ratio (ω_{f} is linearly proportional to ωᵣ), the fluid power rotational speed will therefore also decrease linearly as wind speed decreases, i.e., ω_{f}=ω_{f,rated}(U/U_{rated}) in Region 2 with SMFP. For typical constant-displacement fluid power systems with constant torque, a reduction in rotation rate leads to a commensurate reduction in power (P_{f} approximately decreases linearly with ω_{f}) as shown in FIG. 5. As such, the fluid power for SMFP with a typical constant-displacement fluid power system can be approximately expressed as

| | | |
|---|---|---|
| Region 2 | U_{cut-in} < U < U_{rated} | P_{f} = P_{f, rated} (ωᵣ/ω_{r, rated}) |

As a result, the maximum fluid power that can be sent to storage reduces as wind speed reduces for Region 2, i.e. P_{f}=P_{f,rated} (U/U_{rated}). Since the available rotor power in Region 2 also reduces with wind speed, i.e. Pᵣ=P_{g,rated} (U/U_{rated})³, the generator power (the difference between the rotor and fluid power) for SMFP will be less than that for SMGP and may be zero at the lowest wind speeds of Region 2 since the goal is to maximize fluid power at all wind speeds for SMFP.

The above two super-rated schemes (SMGP and SMFP) can be considered as extreme limits whereby super-rated operation can also occur for conditions in between these limits, which provides high operational flexibility. In particular, operation for super-rated energy storage (typically employed when the energy prices are below the average) can lie anywhere in between FIG. 3 (SMGP) and FIG. 5 (SMFP), where the specific choice may depend on current/forecasted energy price, current/forecasted wind speed, and the amount of remaining storage energy that is available.

For example, when energy prices are very low but positive and the storage system has significant capacity for additional storage, maximum energy storage may be preferred with SFMP. However, when energy prices are moderate but below average and the and the storage system is reaching maximum, maximum energy generation may be preferred with SMGP. And when energy prices are in between very low and moderate values and/or storage system is has intermediate remaining capacity, operations in between SMGP and SFMP may be preferred (tending to SMGP when prices are moderate and tending to SFMP when prices are very low).

1.2.3 Storage with Discrete Fluid Power

Note that Region 3⁺ of SMGP (FIG. 4) described above includes variable fluid power at constant RPM. For a constant-displacement fluid power system at constant RPM, changes in power generally lead to changes in the compressor pressure ratio which may not be ideal for a fluid energy storage system that employs a set storage pressure. To avoid this, a variable-displacement fluid power system can be used to achieve partial power while providing nearly constant pressure ratio. However, a variable-displacement fluid power system will generally increase complexity and cost as well as reduce fluid power efficiency. Therefore, another option for Region 3⁺ is to use a discrete approach which adjusts the fluid power discrete steps while keeping a constant RPM. This can be achieved by using multiple constant-displacement compressor units and allowing one or more units to be deactivated while the other units remain active at their rated displacement and rotation rates. This approach to achieve partial fluid power can be referred to as Storage with Discrete Fluid Power (SDFP). For example, a single-stage four-cylinder reciprocating air compressor at a fixed RPM with all cylinders active would provide 100% power but can be adjusted to deactivate two cylinders for 50% power, or to deactivate all cylinders for 0% power. As an example, FIG. 6 shows a SDFP fluid power system that provides 0% power in Region 2 (like SMGP) but jumps to 50% of power for wind speeds between U_{rated} and (U_{rated}+U_{cap})/2 and then jumps to 100% power for wind speeds between (U_{rated}+U_{cap})/2 and U_{cap}. The electrical generator power would then adjusts accordingly based on the total power available from the rotor. While FIG. 6 shows sudden changes in power with wind speed, a controller can be used to smooth the impact of these discrete power and torque changes to the generator.

1.2.4 Storage with Only Fluid Power

It should be noted that the above schemes are based on maximizing total rotor power and result in rotor power that is greater than the generator power in Regions 3⁺ and 3^{cap}. However, if the energy prices become so low (e.g., negative) such that partial or full generator curtailment (reduced or no electric power to the grid) is appropriate, then the electrical generator can be reduced or set to zero. If the generator power is set to zero (P_{g}=0) at all wind speeds so only fluid power is produced, this is referred to as Storage with Only Fluid Power (SOFP) and is shown in FIG. 7. For SOFP, the rotor power in Regions 2, 3⁺, and 3^{cap} is reduced to be consistent with the fluid power (Pᵣ=P_{f}), where the fluid power is the same as in SMFP. If the fluid power in Region 2 varies linearly with shaft speed (as in the case of a constant-displacement fluid power system) and shaft speed varies linearly with wind speed (as in FIG. 2), the SOFP operation can be approximately described as

| | | | |
|---|---|---|---|
| Region 1 | U < U_{cut-in} | Pᵣ = P_{f} = 0 | ωᵣ ~ 0 |
| Region 2 | U_{cut-in} < U < U_{rated} | Pᵣ = P_{f} = P_{f, rated} (ωᵣ/ω_{r, rated}) | ωᵣ = ω_{r, rated} (U/U_{rated}) |
| Region 3⁺/3^{cap} | U_{rated} < U < U_{cut-out} | Pᵣ = P_{f} = P_{f, rated} | ωᵣ = ω_{r, rated} |
| Region 4 | U > U_{cut-out} | Pᵣ = P_{f} = 0 | ωᵣ ~ 0 |

This assumes that the rotor power is less than or equal to the available rotor power based on conventional operation, i.e.

| | |
|---|---|
| Region 2 | Pᵣ ≤ P_{r, avail} = P_{g, rated} (U/U_{rated})³ |

This inequality will generally be true if the fluid rated power is significantly less than the generator rated power. However, it may be possible to generate additional fluid power in Region 2 for SOFP by allowing higher rotor rotation rates than that described by FIG. 2 so long as Pᵣ≤P_{r,avail} and ωᵣ<ω_{r,rated}.

It should be noted that SMGP, SMFP, and SDFP, SOFP result in rotor power that is greater than the generator rated power in Regions 3⁺ and 3^{cap}, while SOFP generally results in rotor power that is below the generator rated power. Another option is to operate the turbine in between these limits, to provide increased operational flexibility. For example, the rotor power can be prescribed to be consistent with that for conventional operation as in FIG. 1, but with fluid power maximized when the rotor produces power. This scheme can be denoted as Storage with Conventional Rotor Power (SCRP) and the generator power and rotor speed can be expressed as

| | | | |
|---|---|---|---|
| Region 1 | U < U_{cut-in} | Pᵣ = P_{f} = P_{g} = 0 | ω ~ 0 |
| Region 2 | U_{cut-in} < U < U_{rated} | Pᵣ = P_{f, rated} (ωᵣ/ω_{r, rated}) + P_{g} | ωᵣ = ω_{r, rated} (U/U_{rated}) |
| Region 3 | U_{rated} < U < U_{cap} | Pᵣ = P_{g, rated} = P_{f, rated} + P_{g} | ωᵣ = ω_{r, rated} |
| Region 4 | U > U_{cut-out} | Pᵣ = P_{f} = P_{g} = 0 | ωᵣ ~ 0 |

Note that rotor power in Region 2 would be the same as for CO, i.e., Pᵣ=P_{g,rated} (U/U_{rated})³ for SCRP for U_{cut-in}<U<U_{rated}. This approach has the advantage of keeping rotor thrust and torque at all wind speeds for SCRP to be the same as that for CO. As such, structural changes to the hub and rotor would not be required but energy storage is still achieved. Such an approach may be best when energy prices are low but still positive.

In the more general case, the amount of electrical power extracted during storage can be anywhere in between the schemes of SMGP, SMFP, and SDFP and the scheme of SOFP, where SCRP is an example of an intermediate operation between these schemes. This therefore provides maximum flexibility in both design of the system (e.g., the maximum rotor power for any operation can be chosen to lie in between a lower bound of P_{g,rated} and an upper bound of P_{g,rated}+P_{g,rated}) as well as maximum flexibility in system operation (e.g., the electrical generator power operation can vary between a lower bound of 0 and an upper bound of P_{g,rated} while the fluid power operation can vary between a lower bound of 0 and an upper bound of P_{f,rated}) to take optimize based on available wind energy, grid demand (energy prices), and available storage system capacity for further storage.

Regarding capacity, it should be noted that the above storage schemes (SMGP, SMFP, SDFP, SOFP, and SCRP) assume that the fluid storage system is not filled so that additional fluid energy can be stored. However, if the fluid storage system is filled (no energy capacity is left), then the fluid power can be set to zero (P_{f}=0) at all wind speeds so the turbine can revert to Conventional Operation as in FIG. 1 for electrical generation production. If both the fluid storage system is filled (no fluid power to storage is warranted) and full generator curtailment is also appropriate (no electric power to the grid is warranted), then the turbine can revert to fully parked condition at all wind speeds (Pᵣ=P_{f}=P_{g}=0) with no rotor operation (ωᵣ~0).

It should be noted that all the above operational schemes (SMGP, SMFP, SDFP, SOFP, SCRP and flexible operation in between these schemes) have rotor power schedules with wind speed that can be achieved by varying blade pitch as a function of blade speed and wind speed. While the above operational schemes are typically used when energy prices are below the average energy price, the following considers operational schemes with regeneration which are typically used when energy prices are above the average energy price.

1.3 Wind Turbine Operation with Fluid Energy Regeneration

If energy prices are near or above the average such that fluid power energy extraction is desired, the wind turbine operation can employ regeneration of fluid power from energy storage in order to supplement the power from the rotor. During regeneration, the fluid power taken from storage and delivered to the generator is defined herein as positive so P_{g}=Pᵣ+P_{f}. There are three different specific schemes of fluid power with regeneration that are defined herein:
Regeneration with Maximum Fluid Power (RMFP)
Continuous Regeneration with Conventional Rotor Power (CRCRP)
Discrete Regeneration with Conventional Rotor Power (DRCRP)
   In addition, it is noted that operation by minimizing fluid power simply indicates no regeneration and so is the same as Conventional Operation (CO).
   1.3.1 Regeneration with Maximum Fluid Power

The limit of RMFP as shown in FIG. 8, which maximizes electrical generation at all wind speeds by combining the maximum available fluid power with rotor power, subject to the electrical generator limit. For Region 3 of RMFP, the generator is conventionally driven by the rotor at rated speed and at rated power (P_{g}=Pᵣ=P_{g,rated} and P_{f}=0), which is the same as CO. For Region 4 of RMFP, the generator is parked so the power is zero (P_{g}=Pᵣ=P_{f}=0) and rotor rotation is zero (ωᵣ~0), which is the same as CO.

However, Regions 1 and 2 with RMFP will have a higher electrical generator power than CO. In particular, the maximum regenerated fluid power is added to the rotor power to maximize generator power for all wind speeds. Since a fluid power system tends to produce maximum power at its rated speed, RMFP in Regions 1 and 2 will generally produce the most power when the shaft speed is set at the rated speed (ω_{f,rated}) so as to enable P_{f}=P_{f,rated} for all these wind speeds, as shown in FIG. 8. The lowest wind speed where the rotor power and fluid power combine to produce the rated generator power (P_{g,rated}=Pᵣ+P_{f}) in Region 2 can be defined as the fluid-rated regeneration wind speed (U_{f}), as shown in FIG. 8. However, if one employs the rated speed (ω_{f,rated}) in Region 2 to maximize fluid power, the rotor power in Region 2 will be reduced compared to CO since the tip speed ratio will increase above its ideal value as the wind speed decreases. For RMFP in Region 1, there is generally not enough wind speed for the rotor to produce power so only fluid power is produced, which is generally maximized at P_{f,rated} with ω_{f,rated}. In this case, the connected rotor would also spin at its rated rotation speed (ω_{r,rated}) and so the blade pitch should be set to minimize any aerodynamic losses since the rotor may actually consume power (instead of producing power) as shown in FIG. 8. The power consumed by rotor spin in Region 1 can be defined as the aerodynamic power loss (Pₐₑᵣₒ) so that the net power sent to the generator would be the rated fluid power minus this power (P_{f,rated}−Pₐₑᵣₒ). To minimize this aerodynamic power loss, the blade pitch can be reduced so that the average effective angle of attack is nearly zero. As such, it is expected that the aerodynamic lost power is small compared to the regenerated fluid power. However, this lost power may be eliminated if the rotor is disengaged from the generator at these conditions with a clutch system. In this way, the rotor can be parked with rotor speed set at about zero (ωᵣ~0) while the fluid power and generator systems are engaged and rotating at their rated speeds.

Based on the fluid-rated wind speed (U_{f}), a wind speed range of U_{cut-in}<U<U_{f} can be denoted as Region 2⁺ (since it produces more power than conventional Region 2 operation) while the wind speed range of Uᵣ<U<U_{rated} can be denoted Region 2^{f} (since it achieves the rated generator power using fluid power augmentation). The resulting operation for RMFP which includes aerodynamic lost power can be summarized as:

| | | | |
|---|---|---|---|
| Region 1 | U < U_{cut-in} | P_{g} = P_{f, rated} − Pₐₑᵣₒ | ωᵣ = ω_{r, rated} |
| Region 2⁺ | U_{cut-in} < U < U_{f} | P_{g} = P_{f, rated} + Pᵣ | ωᵣ = ω_{r, rated} |
| Region 2^{f} | U_{f} < U < U_{rated} | P_{g} = P_{f} + Pᵣ = P_{g, rated} | ωᵣ = ω_{r, rated} |
| Region 3 | U_{rated} < U < U_{cut-out} | P_{g} = Pᵣ = P_{g, rated} | ωᵣ = ω_{r, rated} |
| Region 4 | U > U_{cut-out} | P_{g} = 0 | ωᵣ ~ 0 |

This operation represents the maximum electrical generation at any wind speed and assumes that there is enough energy stored to allow regeneration at the rated fluid power.

However, if the energy storage is empty or near empty so that energy regeneration is not appropriate, the turbine operation would revert to that of FIG. 1 with a Conventional Operation (CO). As such, RMGP and CO represent the extreme limits of regeneration (from maximum generation to no regeneration) and operation in between these limits can provide high operational flexibility. In particular, regeneration operation (typically employed when the energy prices are above the average) can lie anywhere in between FIG. 8 (RMGP) and FIG. 1 (CO), where the specific choice may depend on current/forecasted energy price, current/forecasted wind speed, and the amount of remaining energy storage capacity that is available. For example, when energy prices (and grid demand) are well above average such that energy regeneration is highly valuable, operations closer to RMGP (FIG. 8) may be preferred. However, if energy prices are above average but moderate, then operations closer to CO (FIG. 1) may be preferred (especially in Region 2^{f}) in order to save the stored energy for conditions when energy prices and grid demand are higher.

1.3.2 Continuous Regeneration with Conventional Rotor Power

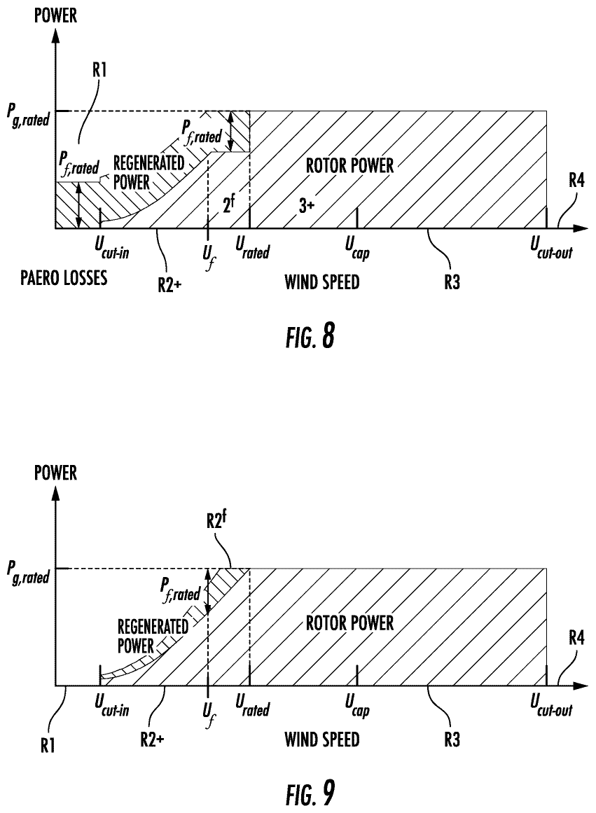

One option that is intermediate to RMGP and CO and allows high rotor efficiency is to operate the rotor at the CO power and rotation speed schedule of FIGS. 1 and 2. For a fluid power system on the same shaft as the rotor or with a fixed gearbox speed ratio, the fluid power rotation speed (ω_{f}) will similarly decrease. For a constant-displacement fluid power system for which power is proportional to rotation rate, the decrease in rotation speed causes the fluid power in Region 2⁺ to also decrease as shown in FIG. 9, and this operation can be designated as Continuous Regeneration with Conventional Rotor Power (CRCRP). For CRCRP in Region 2^{f} the regenerated fluid power would instead decrease (by reducing the fluid power displacement or the expansion pressure ratio) with increasing wind speed to keep the combination of rotor and fluid power constant at the generator rated value. The resulting operation for CRCRP can then be summarized as:

| | | | |
|---|---|---|---|
| Region 1 | U < U_{cut-in} | P_{g} = 0 | ωᵣ ~ 0 |
| Region 2⁺ | U_{cut-in} < U < U_{f} | P_{g} = P_{f} + Pᵣ | ωᵣ = ω_{r, rated} (U/U_{rated}) |
| Region 2^{f} | U_{f} < U < U_{rated} | P_{g} = P_{f} + Pᵣ = P_{g, rated} | ωᵣ = ω_{r, rated} (U/U_{rated}) |
| Region 3 | U_{rated} < U < U_{cut-out} | P_{g} = Pᵣ = P_{g, rated} | ωᵣ = ω_{r, rated} |
| Region 4 | U > U_{cut-out} | P_{g} = 0 | ωᵣ ~ 0 |

This operation assumes that there is enough energy stored to allow regeneration at the fluid power. If there is not enough energy or if the energy demand is too low to release regenerated energy, the operation would revert to no regeneration, i.e. to Conventional Operation (CO).
1.3.3 Discrete Regeneration with Conventional Rotor Power

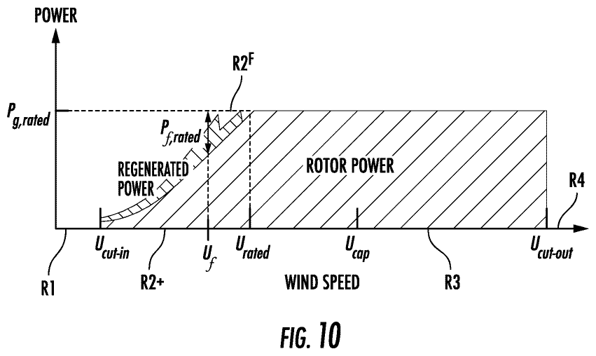

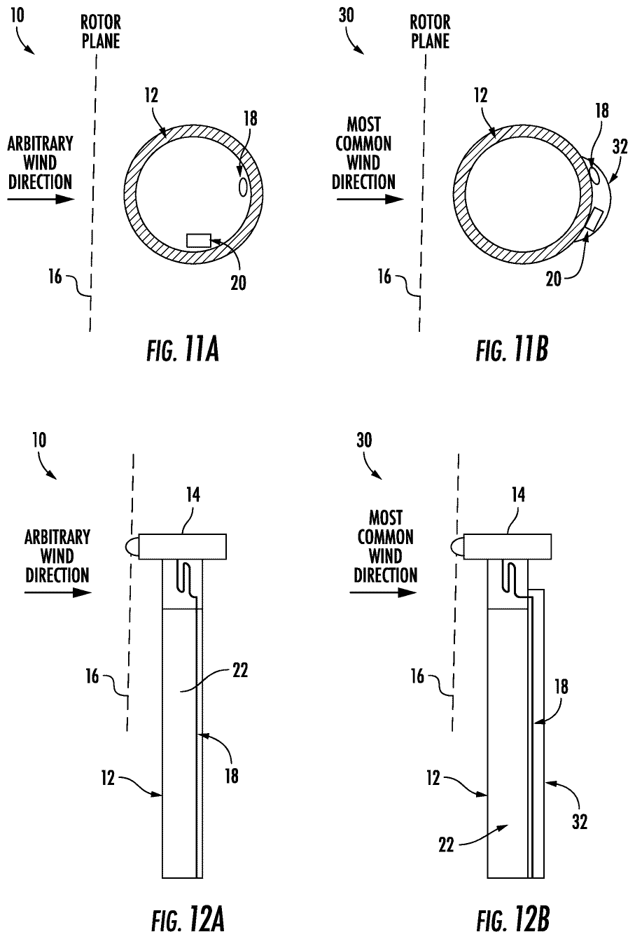

A modification to CRCRP which avoids the need for variable fluid power in Region 2^{f} is to operate using Discrete Regeneration with Conventional Rotor Power (DRCRP). For DRCRP, the fluid power energy regeneration system is composed of multiple constant-displacement expander units and the system can allow one or more units to be deactivated while the other units remain at their individual full power to achieve partial fluid power for the entire system. The DRCRP approach can allow discrete changes in fluid power regeneration in Region 2^{f} as shown in FIG. 10, so that the rated generator power is not exceeded.

### 1.4 Tower Side Casing and Rotor Operation

Super-rated wind turbine operation with compressed air energy storage may optimally store pressurized air and/or other fluids within the tower as discussed by Qin 2013 and Qin et al. 2016. This can be extended herein to include any of the energy storage schemes discussed in Section 1.2 (SMGP, SMFP, SDFP, SOFP, and SCRP). In general, the tower shell thickness may be adjusted and/or increased to handle the increase air pressure with the tower and this adjusted/increased shell thickness and the high pressure in the tower can significantly stiffen the tower. This may call for the tower to be designed as stiff-stiff structure instead of a soft-stiff structure, especially for large wind turbine with high rated powers.

If the interior of the tower is used for storing compressed air, it may be beneficial to move some or all of the wind turbine components that are typically located inside the tower cylinder to instead be located outside this cylinder, so the components are not exposed to high pressures and so the tower cylinder can be better sealed for high pressure conditions. These components can include the electrical cables (that carry power from the generator to the base of the tower) as well as access ladders and/or elevators. To protect them from the ambient elements, these components can be enclosed in a separate volume, denoted herein as the “tower side casing”, which is attached to the side of the tower but outside of the main cylindrical tower volume.

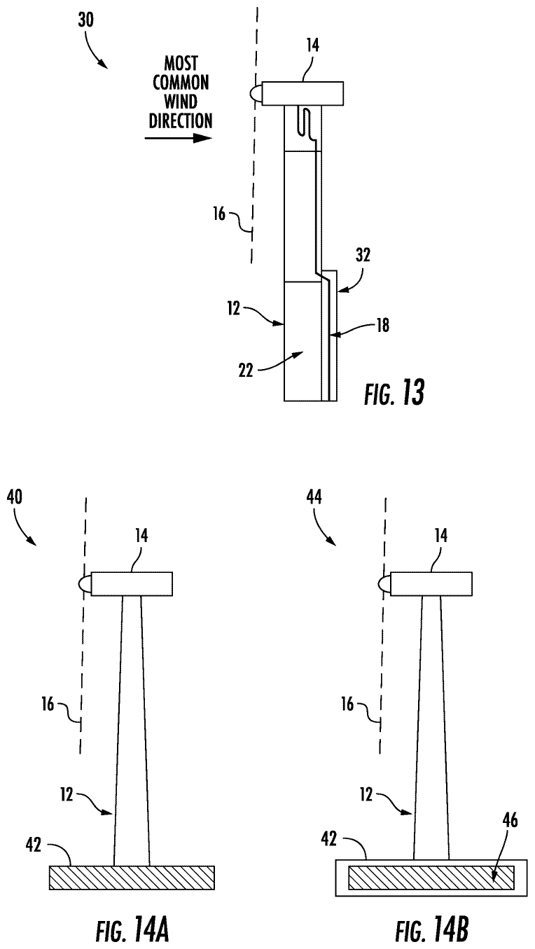

FIGS. 11a and 12a show a conventional wind turbine 10 having a tower 12 supporting a nacelle 14 upon which is disposed a rotor 16. Electrical cables 18 and a ladder and/or elevator 20 are enclosed in a tower volume 22. FIGS. 11b and 12b show a wind turbine 30, in accordance with the present disclosure, including a tower side casing 32, which houses the components 12, 14 for a vast majority of the tower length. In order to minimize interference with rotor operation, a tower side casing 32 would generally be mounted on the side of the tower 12 where the rotor 16 is least likely to be operated. For a turbine with an upwind rotor (whereby the rotor 16 operates upwind of the tower 12 as shown in FIGS. 11 and 12), the least likely position for operation would be on the side of the tower where the direction of the oncoming wind has the lowest probability of occurrence. For example, if the wind is least likely to come from the west, a tower side casing 32 for an upwind turbine 30 may best be mounted on the west side of the tower 12.

Adding a tower side casing 32 will reduce the clearance between the rotor 16 and the tower 12 (rotor-tower clearance) when the rotor 16 is located close to the tower side casing 32. In particular, there may be a set of rotor yaw angles where this clearance will be reduced, especially when the rotor 16 is exactly on the same side as the tower side casing 32. As such, there will be a sector of rotor yaw angles and wind speeds where the rotor-tower clearance will be more problematic. To address this, the rotor operation can be modified in at least two ways:
a) yaw control to eliminate a prescribed sector of yaw angles for rotor operation, especially for conditions near rated (maximum) thrust and for high wind unsteadiness
b) thrust control to reduce the peak thrust of the rotor (such peak shaving can be readily accomplished with blade pitch control) for a prescribed sector of yaw angles for which the rotor is close to a tower side casing.
   While both these types of control will reduce the clearance problem, they will also reduce the power produced by the wind turbine for operation in the yaw angle sector where an adjustment is made. However, by relegating these yaw angles to the angles where wind power is least likely to be produced, the net effect on the annual wind energy can be expected to be small. For example, the wind energy produced for a 60-degree sector angle of the least common wind directions at near rated conditions for a typical wind farm site may be less than 5% of the annual wind energy. If the above yaw and/or thrust control strategies on average reduce the instantaneous power for these conditions by less than 20%, then the net reduction in annual wind energy for this site will be less than 1%. Furthermore, enhanced rotor stiffness, rotor tilt, rotor coning, and/or rotor pre-bend can be applied to address the reduced rotor-tower clearance associated with the addition of a tower side casing.

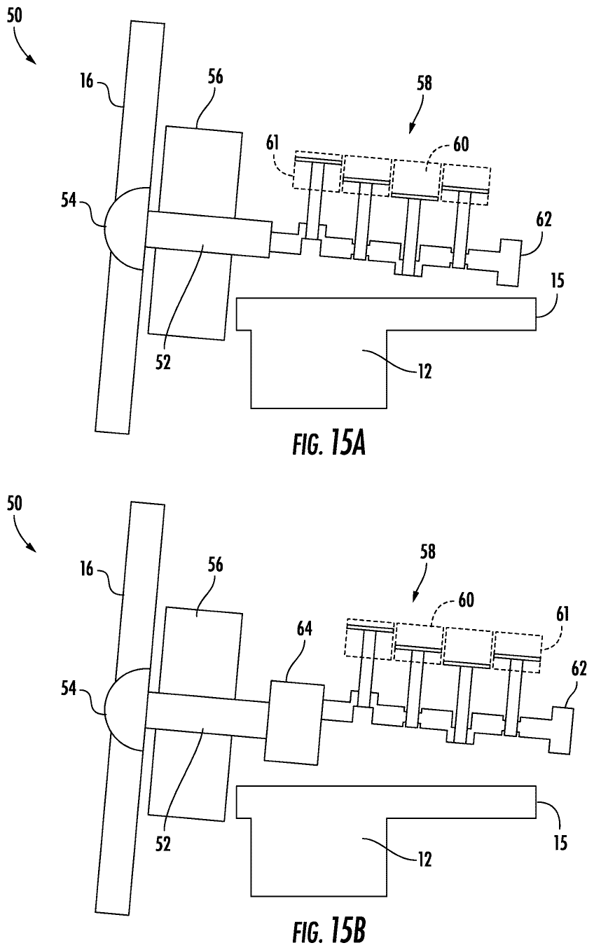

Another option is to employ a partial tower side casing 32 for the portion of the tower 12 below the rotor sweep region as shown in FIG. 13. In this case, the pressurized section may be limited to the tower section below the rotor sweep region. While this reduces the size of the pressure vessel in the tower, it avoids the rotor-tower clearance issue so that the yaw and/or thrust control need not be limited as a function of wind direction for the tower side casing. In addition, the pressure vessel section may continue into the foundation for an onshore turbine, into the monopile for an offshore fixed-bottom turbine, or into the stem and buoyancy cans for a floating wind turbine.

Another option is to include multiple tower side casings. For example, one tower side casing can be used for the electrical connections, a second tower side casing can be used for worker access, and a third tower side casing can be used for components of the energy storage system.

Another option to control tower loads and dynamics is to include a liquid, such as water, in a cylindrically-shaped tower and allow it to slosh back and forth in order to provide a tuned mass damper. In general, the damping will be greatest when the frequency for sloshing frequency matches the back-and-forth structural frequency of the tower. The sloshing frequency is primarily a function of the cylinder diameter while the structural frequency is a function of tower stiffness and mass. As such, the tower stiffness, mass, and diameter can be designed to ensure that the sloshing frequency matches well with the structural frequency. The liquid volume can also be adjusted to optimize damping in extreme load conditions. Including liquid in the tower can also be helpful to provide isobaric compressed air energy storage where the amount of liquid is adjusted to make up for any air volume changes. Notably, liquid in the tower will increase mass which may reduce the tower natural frequency.

### 1.5 Other Forms of Energy Take-Off

In addition to using fluid power for power take-off and regeneration, other forms of power take-off and stored power may be used. For example, the fluid power taken off in the schemes described in Section 1.2 can be replaced with an electrolysis power take off to generate hydrogen, and the hydrogen gas can be stored within the tower (and/or in the monopile for an offshore fixed-bottom wind turbine and/or in the buoyancy volume for an offshore floating wind turbine). If the pressure is high enough, the hydrogen may be liquified, which can greatly increase the storage capacity of the tower in terms of hydrogen mass. The power take off can also be used for water desalination to create freshwater from salt water, which may be enabled by an offshore saltwater site for the wind turbine.

Energy storage power take-off and regeneration can also be used to raise/lower large masses within the tower (and/or the monopile for an offshore fixed-bottom wind turbine) in order to store and regenerate gravitational potential energy. The power take-off and regeneration can also be used to drive a fly wheel within the tower (and/or the monopile for an offshore fixed-bottom wind turbine) to store rotational kinetic energy. The flywheel can also be designed to be part of the base of the turbine, so that the flywheel mass also serves as foundation mass. FIG. 14A shows a conventional onshore wind turbine 40 with the tower 12 disposed upon a base 42 formed of concrete. FIG. 14B shows a wind turbine 44 in one embodiment of the present disclosure in which the tower 12 is mounted upon the base 42 and a rotating flywheel 46 is disposed in a housing within the base 42 and connected to the rotor and generator for power generation.

### 2.1 Theory of Air Compressors/Expanders

For compressed air energy storage, a pneumatic compressor is characterized by the Pressure Ratio of Compression (PR_{com}), which is the ratio of the final gas pressure after compression (p_{t,com}) relative to the initial gas pressure before compression (p_{i,com}), i.e.

$$P {R}_{com} = {p}_{f , com} / {p}_{i , com}$$

Generally, the initial pressure (p_{i,com}) is nearly equal to the ambient pressure (pₒ), but is slightly lower due to flow pressure losses during intake. The final pressure (p_{f,com}) is typically set as nearly equal to the storage chamber pressure (pₛₜₒᵣₑ) but is at least slightly higher to allow for flow line pressure losses between the compressor/pump and the storage vessel. The maximum storage pressure (p_{store,max}) is typically set by the container structural safety limits and can vary broadly, e.g., from 1 MPa to 40 MPa. This corresponds to an approximate PRₘₐₓ range of 10 to 400 based on sea-level ambient conditions for the inlet pressure.

For compressed air energy regeneration, a pneumatic expander is characterized by the Pressure Ratio of Expansion (PRₑₓₚ), which is the ratio of the initial gas pressure before expansion (p_{i,exp}) relative to the final gas pressure after expansion (p_{f,exp}), i.e.

$$P {R}_{exp} = {p}_{i , exp} / {p}_{f , exp}$$

The inlet pressure for expansion is set nearly equal to the storage chamber pressure but will be slightly lower to account for flow line pressure losses between the storage vessel and the expander/motor. Similarly, the outlet pressure after expansion is nearly equal to the ambient pressure but is typically slightly higher to allow for flow pressure losses during exhaust.

The pressure ratios for compression and expansion are related to the associated volumetric ratios for compression and expansion, which are the ratios of the largest volume to the smallest volume of air (or another gas) for these processes. In particular, the volumetric Compression Ratio (CR) for a single cylinder is based on the ratio of the initial volume of air (V_{i,com}) to the final volume of air (V_{f,com}) for a single cycle

$$CR = {V}_{i , com} / {V}_{f , com}$$

This reflects the ratio of the volume of air just before compression starts relative to the volume of air just after compression ends for a single cycle. Similarly, the volumetric Expansion Ratio (ER) for a single cylinder is based on the ratio of the final volume (V_{f,exp}) to the initial volume of air (V_{f,exp}) for a single cycle

$$ER = {V}_{f , exp} / {V}_{i , exp}$$

This reflects the ratio of the volume of air just after expansion ends relative to the volume of air just before expansion starts for a single cycle.

During compression and expansion of gas, there may be both thermal and non-thermal energy losses. Non-thermal losses include fluid/solid friction losses, mechanical losses, valving losses etc. while thermal losses are due to temperature changes in the gas during compression or expansion. These temperature changes generally increase as the pressure changes increase, which, in turn, depend on the degree of volume changes. These changes can be analytically described for a polytropic process, which is defined as volume changes of an ideal gas in a closed system with negligible changes in kinetic and potential energy. If one ignores the non-thermal losses, the volume ratios for compression and expansion can be thermodynamically related to their respective pressure ratios using the polytropic gas exponent (n) for a polytropic process such that

$$P {R}_{com} = {( C R )}^{n}$$

$$P {R}_{exp} = {( E R )}^{n}$$

In general, the polytropic index for compression and for expansion need not be equal and can depend on a number of system factors and operating factors since the polytropic exponent (n) is process dependent. There are two key theoretical limits for a polytropic process. For an adiabatic process (no heat transfer), the polytropic exponent (n) equals the ratio of gas specific heats (g), where g=1.4 for air at standard conditions. For an isothermal process (constant temperature), the polytropic exponent equals unity, i.e., n=1. For intermediate conditions (with finite heat transfer and finite temperature change), the polytropic exponent will be in between these limits, i.e., 1<n<g.

For a polytropic process, the ratio of the final to initial temperature changes for compression (T_{com,f}/T_{com,i}) and for expansion (T_{com,f}/T_{com,i}) are related to the polytropic exponent and the pressure ratios as

$${T}_{com , f} / {T}_{com , i} = {( P {R}_{com} )}^{( 1 - 1 / n )}$$

$${T}_{exp , f} / {T}_{exp , i} = {( 1 / {PR}_{exp} )}^{( 1 - 1 / n )}$$

Note that n=1 yields constant temperature, despite changes in pressure.

To determine the power requirements for a polytropic process, one must also consider the volumetric flow rates. For both compression and expansion, the cycle-averaged volumetric gas flow rate (Q) can be defined at ambient pressure (pₒ), where pₒ=101,320 Pa/m² (about 0.1 MPa) for sea-level conditions. If the compressor/expander system uses cylinders, the cycle-averaged volumetric flow rate (Q) is the ratio of the gas volume at ambient pressure that passes through the system divided by the cycle time (t_{cycle}) and equals for Q_{com} compression and Qₑₓₚ for expansion.

If the dead air volume is neglected and air is pulled in at nearly ambient pressure, the initial volume of air just before compression (V_{i,com}) can be used to determine the compression volumetric flow rate as

$${Q}_{com} = {V}_{i , com} / {t}_{cycle}$$

For compression, dead air volume is the residual volume of high-pressure air that does not get pushed out into storage and instead remains in the cylinder. Ideally, this compression dead volume is very small relative to the volume of air that is pushed out so that the above flow rate relationship is approximately realized. However, some dead volume of air will remain in practice due to valve clearance requirements and geometry effects.

Similarly for expansion, the volumetric flow rate can be based on the final volume of air just after expansion (V_{f,exp}) if the dead air volume is again neglected and air is exhausted at nearly ambient pressure, i.e.

$${Q}_{exp} = {V}_{f , exp} / {t}_{cycle}$$

For expansion, dead air volume is the residual volume of low-pressure air that does not get exhausted to the ambient. Ideally, this expansion dead volume is very small relative to the volume of air that is exhausted so that the above flow rate relationship is approximately realized.

If the initial pressure for compression is equal to the ambient pressure (p_{i,com}=pₒ) and non-thermal losses are neglected, the pneumatic power required for compression (P_{com}) and the pneumatic power extracted during expansion (Pₑₓₚ) for a polytropic process can be related to the volumetric flow rates, the pressure ratios, and the polytropic index as

$${P}_{com} = {p}_{o} {Q}_{com} [ n / ( n - 1 ) ] ( {PR}_{c o m}^{( n - 1 ) / n} - 1 )$$

$${P}_{exp} = {p}_{o} {Q}_{exp} [ n / ( n - 1 ) ] ( {PR}_{exp}^{( n - 1 ) / n} - 1 )$$

These expressions employ pₒ as the ambient pressure and define power as a positive value for both compression and for expansion.

If again the initial pressure for compression is equal to the ambient pressure (p_{i,com}=pₒ) and non-thermal losses are neglected, the isothermal pneumatic fluid power (P_{com,iso}) is related to the pressure ratio and cycle-averaged volumetric flow rate as

$${P}_{c o m , i s o} = {p}_{o} {Q}_{com} ln ( {PR}_{c o m} )$$

Similarly for expansion with a final pressure equal to the ambient pressure (p_{f,exp}=pₒ) and neglecting non-thermal losses, the isothermal pneumatic fluid power extracted during expansion (P_{exp,iso}) can be related to the expansion pressure ratio and cycle-averaged volumetric flow rate as

$${P}_{exp , iso} = {p}_{o} {Q}_{exp} ln ( {PR}_{exp} )$$

These isothermal expressions for compression and expansion power can be obtained by considering the polytopic expressions for compression and expansion power in the limit of n=1.

The differences between the isothermal power and the polytropic power for a process is defined as the thermal power loss, which is caused by air temperature variations. In particular, temperature generally increases during gas compression (as used for energy storage) and much of this thermal energy will be lost during long-time storage as the air cools (heat is lost to the environment) resulting in a loss of storage pressure. This pressure reduction during storage reduces the available compressed air energy available for recovery during expansion (i.e. for energy regeneration). In addition, temperature generally decreases during gas expansion (as used for energy regeneration). This decrease in temperature further reduces the gas pressure during the expansion which reduces the extracted pressure work. These thermal losses for both compression and expansion can be avoided in the idealized case of an isothermal process (n=1) which has no temperature increase during compression and no decrease during expansion. Therefore, as compared to the isothermal cases with n=1, the more general case with n>1 requires more power for compression (i.e., P_{com}>P_{com,iso}) and extracts less power during regeneration (Pₑₓₚ<P_{exp,iso}).

To quantify the degree of thermal loss, the above relationships (which ignore non-thermal losses) can be used to define the thermal efficiencies. For a given compression pressure ratio and flow rate, the compression thermal efficiency (η_{com}) is the ratio of isothermal fluid compression power (P_{com,iso}) relative to the fluid compression power for finite temperature changes (P_{com})

$${η}_{c o m} = {P}_{c o m , i s o} / {P}_{c o m}$$

This will be generally less than unity indicating more compression power is required for the general case than for the isothermal case. Similarly, for a given expansion pressure ratio and flow rate, the thermal efficiency for expansion (ηₑₓₚ) is the ratio of the fluid expansion power for finite temperature changes (Pₑₓₚ) relative to the isothermal fluid expansion power (P_{exp,iso}) as

$${η}_{exp} = {P}_{exp} / {P}_{exp , iso}$$

This will be generally less than unity indicating less expansion power is regenerated for the general case than for the isothermal case. The thermal round trip efficiency (η_{RT}) is the product of these two efficiencies for a given pressure ratio and flow rate

$${η}_{R T} = ( {η}_{c o m} ) ( {η}_{exp} )$$

In the isothermal limit where there are no temperature changes, the thermal efficiency is 100%, i.e.

$${η}_{com , iso} = {η}_{exp , iso} = {η}_{RT , iso} = 1$$

However, the actual thermal efficiencies will be generally less than unity due to losses during compression and during expansion so that

$${η}_{com} < 1 , {η}_{exp} < 1 , and {η}_{R T} < 1$$

Combining the above expressions for P_{com} and P_{com,iso}, the thermal efficiency for compression (neglecting non-thermal losses) is

$${η}_{com} = ln ( {PR}_{com} ) / \{ [ n / ( n - 1 ) ] ( P {R}_{com}^{( n - 1 ) / n} - 1 ) \}$$

The limit of n=1 (isothermal compression) yields η_{com,iso}=100%, while n>1 (some temperature rise) yields η_{com}<100%. As an example, PR_{com}=50 with n=1.4 yields η_{com}54%. This indicates that 46% of the energy is lost during compression for adiabatic conditions. If one considers a lower pressure ratio, the adiabatic losses are reduced (e.g., PR_{com}=20 with n=1.4 yields η_{com}=63%), but a lower PR also yields a lower energy storage density (which reduces the storage capacity).

Combining the above expressions for Pₑₓₚ and P_{exp,iso}, the thermal efficiency for expansion (neglecting non-thermal losses) is

$${η}_{exp} = ln ( {PR}_{exp} ) / \{ [ n / ( n - 1 ) ] ( {PR}_{exp}^{( n - 1 ) / n} - 1 ) \}$$

Again, the limit of n=1 (isothermal expansion) yields η_{exp,iso}=100%, while n>1 (some temperature drop) yields ηₑₓₚ<100%.

Note that the above thermal efficiency definitions neglect the push-out process (when the compressed air is pushed from the piston chamber into the storage vessel) and the fill-in process (when the compressed air from the storage is released into the cylinder so it can then be expanded). A different approach to include the push-out process and the fill-in process for the thermal efficiencies is described by Simpson et al. (2023a).

Based on the above, near-isothermal compression and expansion for compressed air energy storage (n_{com}~nₑₓₚ~1) is needed to achieve an isothermal round-trip efficiency of nearly 100%. The following describes approaches to achieve that goal.

### 2.2 Direct-Drive Air Compressor/Expander Concept

An air compressor/expander system for a wind turbine is proposed whereby the pneumatic power (to and from storage) is connected to the rotor shaft and which may include an intermediary gear ratio but does not include any intermediary hydraulic power. Using such a direct approach for the pneumatic power avoids the extra complexity, losses, and costs for intermediary hydraulic power. In addition, as will be shown, a low-speed drive approach (with no gearing or a moderate amount of gearing for the fluid power system) allows compression and expansion to enable near-isothermal conditions. In the following, air is described as the gas used for pneumatic power, since air is typically readily available from the atmosphere and does not require special storage. However, the system can also be applied to other gases.

Offshore large wind turbines with more than 10 MW of rated power typically employ direct-drive electrical generators so as to avoid the use of gearboxes (since the gearboxes can be very heavy at these power levels and require significant maintenance, which is not ideal for offshore locations). As such, these offshore wind turbines have direct-drive electrical generators which can operate efficiently at the low-speed rotation rates of a wind turbine rotor (typically less than 20 RPM).

There are many design options available for the air compressor/expander including a reciprocating (piston-based) design, a scroll compressor, a screw compressor, a centrifugal compressor and an axial compressor. For the low-speed shafts associated with a direct-drive electrical generator, the reciprocating, scroll and screw compressors may be ideal and may be used in combination, e.g. a screw compressor is used as a first-stage and a reciprocating system is used for a second stage. For reciprocating, scroll and screw compressors, some or all of the fixed-area fluid passages may be filled with porous mesh material to promote heat transfer while the variable-area fluid passages may include liquid spray to promote heat transfer.

For the high-speed shafts associated with a geared electrical generator, the centrifugal and axial compressors may also be employed and combined with a turbine for expansion. These systems can also be single-stage and multiple-stage. For centrifugal and axial compressors, some or all of the fluid passages between and within the stages may be filled with porous mesh material and/or liquid spray to promote heat transfer.

To minimize structural mass for such large displacement volumes combined with high pressure ratios within a single-stage system, a piston-based (reciprocating) compressor/expander 58 on a crankshaft 62, as shown in FIGS. 15-17, may be ideal. In these figures, the fluid power system is located within the nacelle of the wind turbine, but the fluid power system may also be located within the nosecone, and/or within the front frame, and/or adjacent to the generator, and/or within the tower.

For such an offshore wind turbine, FIG. 15a shows a direct-drive electrical generator approach combined with a direct-drive fluid power approach, where the latter uses compressor/expander pistons 60. A turbine 50 is shown having the nacelle bedplate 15 disposed upon the tower 12 with a rotor shaft 52 extending from a hub 54 of the rotor blade 16 through a direct drive electrical generator 56 to an air compressor/expander 58 containing the pistons 58. These pistons 60 are driven by a crankshaft 62 that connects to the rotor shaft 52. This direct-drive fluid power approach is beneficial and compatible for such direct-drive electrical generator wind turbines 50 since it avoids adding a gearbox for electrical power conversion in the nacelle 14.

However, another option is to include a gearbox 64 to increase the relative rotation rate of the compressor/expander 58, as shown in the example of FIG. 15b. Increasing the rotation rate of the compressor/expander 58 has the benefit of reducing the size of the pistons 60 for a given volumetric air flow rate. However, the Pneumatic Gear Speed Ratio (PGSR) for the compressor/expander 58 is expected to be moderate, e.g. ranging from 1.5 to 30, since efficient compression/expansion will generally require lower speeds. For the compressor/expander 58, a low-gear-ratio-drive as in FIG. 15b may be preferred over a direct-drive as in FIG. 15a if the cost savings associated with a smaller size of the reciprocating system more than offset the additional costs associated with adding a moderate gear ratio, e.g. ranging from 1.5 to 30. The gearbox or gearing mechanism (such as chain rings with chains) to couple the rotor rotation to the compressor/expander crankshaft with this gear ratio can also be placed in front of the electrical generator. This can be beneficial since shaft mass can be reduced by increasing rotation rate for a given power level.

Moderate gearing the fluid power system can also reduce the size of the compressor/expander, which may allow the compressor/expander and the associated gearing system to be instead located in front of the hub so that a fluid power drive shaft need not pass through the electrical generator.

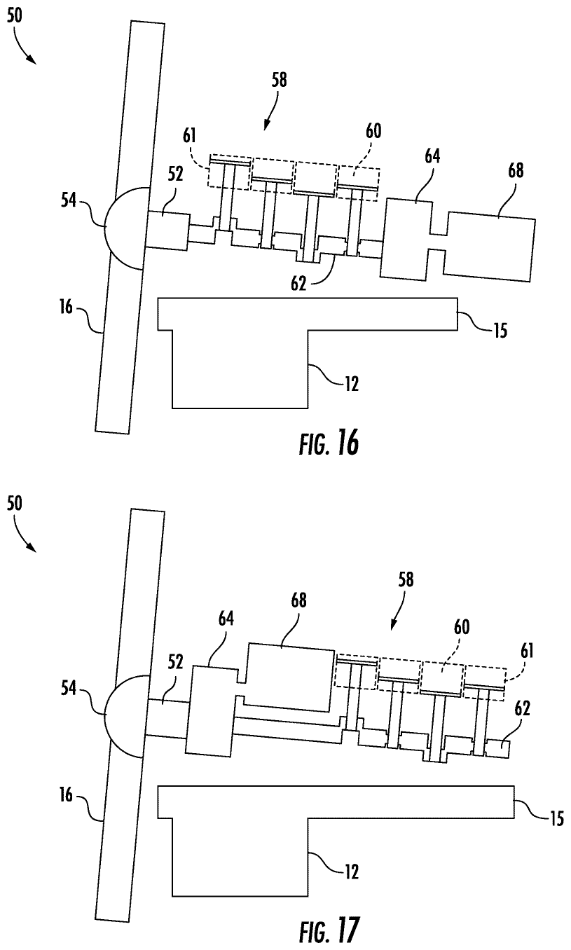

For onshore turbines of less than 10 MW, gearboxes in the nacelle are more commonly used to drive the electrical generator. In particular, with reference to FIG. 16, the gearbox 64 is driven by the low-speed rotor shaft 52 (typically less than 20 RPM) to produce power through a high-speed shaft 66 (typically more than 200 RPM), which delivers power to a high-speed electrical generator 68. Typical gearbox speed ratio for the electrical generator 68 may range from 40:1 to 120:1. However, the compressor/expander 58 may be directly connected to the low-speed rotor shaft 52 (instead of the high-speed electrical generator shaft 66) as shown in FIG. 16. Locating the fluid power (pneumatic) system between the rotor 16 and the generator 68 as shown in the figure avoids the need to extend a low-speed shaft aft of the gearbox.

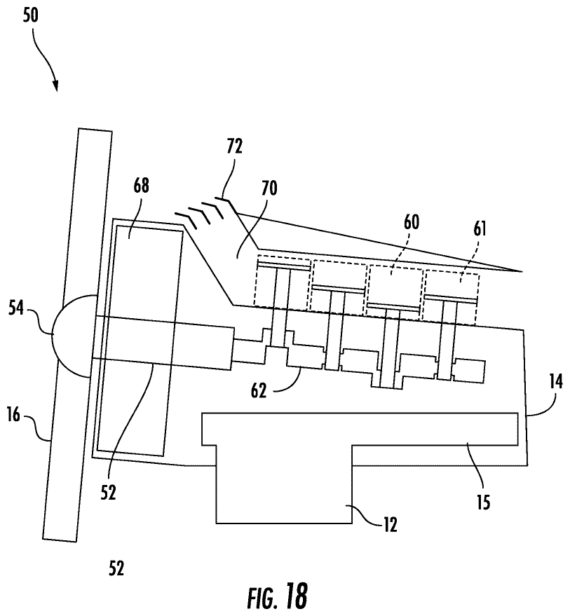

In addition, the fluid power (pneumatic) system could also be employed on the aft side of the gear box 64 as well as shown in FIG. 17. This aft location for the fluid power system may be advantageous since it positions the heavier gearbox 64 and generator 68 further upwind, which will minimize downwind bending moment on the tower 12. In addition, the configuration may allow the shaft 62 of the compressor/expander 58 to be connected to a low-speed shaft out of the gear box 64. The compressor/expander 58 may also be directly connected to a medium-speed rotor shaft out of the gearbox. Connecting to the gearbox can provide a moderate PGSR, e.g., ranging from 1.5 to 30. Furthermore, this aft location for the fluid power system may facilitate integration of a clutch system so that the fluid power system can be decoupled from the rotor shaft 52 when fluid power is not being extracted or regenerated. With such decoupling, the rotor 16 and electrical generator 68 can produce conventional power while the fluid power system can be stationary. A stationary fluid power system would eliminate frictional losses in the fluid power system when fluid power coupling is not needed. A clutch system can also allow the fluid power system to be decoupled if it is not functioning properly so that the electrical energy generation can continue in the interim. This may be especially helpful for remote wind turbines for which inspection, servicing, and repair of the fluid power system may be costly and slow.

In general, nacelle 14 is used to cover most of the components above a nacelle bedplate to provide protection against ambient conditions. To facilitate heat transfer between cylinders 61 of the pistons 60 and the wind, the nacelle 14 can include an internal air duct 70 to capture some of the upstream wind and pass this flow over cylinder surfaces 61 to provide convective heat transfer after which this ducted air may be exhausted out the aft side of the nacelle. FIG. 18 shows an example cross-section of this ducting for the wind turbine 50 with direct-drive electrical generator (as in FIG. 15A). The inflow duct path 70 can include turning vanes 72 as shown in FIG. 18 as well as an inlet grille or grilles to filter and direct the oncoming flow. To enhance the convection speed, a fan can be included in the duct passage 70 to provide forced convection. In addition, the nacelle 14 can be designed so that cylinder surfaces 61 protrude out of the top of the nacelle 14 so that they are directly exposed to the oncoming wind (and no internal ducting is needed). For a wind turbine with a gearbox used to drive the electrical generator (as in FIGS. 16 and 17), similar types of internal air ducting or direct exposure can be used in order to pass air flow over the cylinder surfaces 61.

In addition, the wind inflow path of FIG. 18 could be used to capture the ambient inflow for compression while the outflow flow path of FIG. 18 can be used to exhaust the ambient outflow from expansion. In addition, the wind inflow duct may be located at the nose cone in front of the hub to capture some of the upstream wind.

### 2.3 Reciprocating Cylinder Configuration and Cycle Times

Fluid power for a given pressure ratio is proportional to volumetric flow rate, which is, in turn, proportional to rotation rate and displacement volume. As such, the combination of high power and low RPM of a wind turbine rotor for the pneumatic systems of FIGS. 15-17 will result in large displacement volumes.

For the (reciprocating) compressor/expander shown in FIGS. 15-17 for a single-stage system, the piston-based cylinders 61 are located above the rotor shaft 52 to avoid interference with the bedplate of the nacelle 14 and the tower 12. In addition, the crankshaft 62 can be tilted to accommodate the tilt of the rotor shaft 52 (and the pistons 60 are tilted to accommodate the tilt of the rotor 52). In addition, a multiple-stage system may be well suited for high pressure ratios, where the first stage (which may include one or multiple cylinders if based on a reciprocating system) is connected to ambient air and operates at the lowest pressures while the final stage (which may include one or multiple cylinders if based on a reciprocating system) is connected to the compressed air storage chamber and operates at the highest pressures.

To ensure the power is extracted and regenerated smoothly over each cycle for a reciprocating system, multiple pistons 60 may be ideal. For example, a single-stage system could include a straight-four orientation (four cylinders 60 in line) as shown in FIGS. 15-18, which is a very common cylinder arrangement for car engines and give smooth power performance. An example two-stage system with four inline cylinders could include two first-stage (low-pressure) cylinders and two second-stage (high-pressure) cylinders. Other inline cylinder options could include a straight-six or straight-eight, etc. In addition, V configurations with an even number of pistons can be employed. However, inline pistons may be preferred over V configurations for the Liquid Layer And Meshes with Mechanical Piston (LLAMMP) approach discussed in Section 2.5 since they allow a vertical or near vertical orientation. In general, the cylinders 61 can be used for both air compression (energy storage operation) and air expansion (energy regeneration operation).

For a piston-based system on a crankshaft, each cylinder 61 can be driven by a piston 60 linked to the crankshaft 62 by a connecting rod 74 as shown in FIGS. 19A-B. The piston 60 advances towards a cylinder head 76 (half the cycle time) and then recedes towards the crankshaft 62 (the other half of the cycle time). The piston 60 and cylinder 61 may be constructed of metal (such as steel or aluminum) and/or a composite material (such as fiberglass). In general, a cylinder casing 78 at the side and top of the chamber will be exposed to the highest pressures and thus may require extra reinforcement (FIGS. 19A-B). This could include fiberglass or carbon fiber wrap to reduce weight and cost of the chamber, but metals may also be used. To improve heat transfer, materials with high thermal conductivity, such as steel or aluminum, may be preferred for most or all of the cylinder surfaces. One option is to use the tower shell to serve as the cylinder casing or support the cylinder casing since the tower shell is typically made of thick steel and so the shell can provide good thermal conductivity as well as structural support for the elevated air pressures of the cylinder.

The cylinder head 76 for a single-stage system is connected by flow lines to both the compressed air energy storage tank and to the ambient-pressure atmosphere. The connection to the storage tank is controlled by a storage valve 80 (or storage valves) while the connection to the atmosphere is controlled by an ambient valve 82 (or ambient valves). FIGS. 19A-B show an example cylinder 62 with a single storage valve 80 and a single ambient valve 82, viewed from both side and rear views. As shown in the side view (FIG. 19A), an emergency relief valve 84 (or valves) can be placed at the cylinder head 76 to ensure that the pressurized air does not exceed the safety limits of the piston 60 and chamber. The side view also includes possible tilt due to tilt of the rotor shaft 52 and the crankshaft 62.

For direct-drive compression from the low-speed rotor shaft of a wind turbine, the cycle time in seconds can be related to the rotor RPM as

$${t}_{cycle} = ( 60 sec / min ) / {RPM}_{r o t o r}$$

The rotation rates of wind turbine rotor shafts are typically less than 20 RPM which leads to long cycle times as compared to typical air compressors/expanders. For example, a rotor shaft speed of 6 RPM yields a cycle time of 10 seconds. These slow speeds provide several advantages. First, they reduce the air velocities through the valves 80, 82, 84 and through the flow lines that are connected to the storage chamber and to the ambient surroundings, which reduce the fluid dynamic pressure losses. Second, long cycle times can allow near-isothermal compression and expansion, as discussed in Section 2.5, to enhance round-trip efficiency. Third, slow speeds allow the valve timings to be more precise (relative to the cycle time period) and allow conventional valve cams to be more easily replaced by electro-hydraulic, electro-mechanical, or electromagnetic valves. This can save system weight for the valve system while also allowing increased control and variability of valve timing, which is helpful for the operations discussed in Sections 2.4.

However, long cycle times result in very large displacement volumes and high torques, which can increase the overall mass of the compressor/expander system. To reduce the displacement volume and torque, the compressor/expander can be operated at a higher speed that the rotor shaft. For the case where a moderate gear speed ratio (e.g., 1.5 to 30) is used for the reciprocating compressors/expanders, the cycle time in seconds will be reduced for PGSR>1 as

$${t}_{cycle} = ( 60 sec / min ) / [ ( {RPM}_{r o t o r} ) ( PGSR ) ]$$

For example, a PGSR of 4 approximately yields a four-fold reduction in the cycle time, the displacement volume, and the torque.

### 2.4 Valve Timing

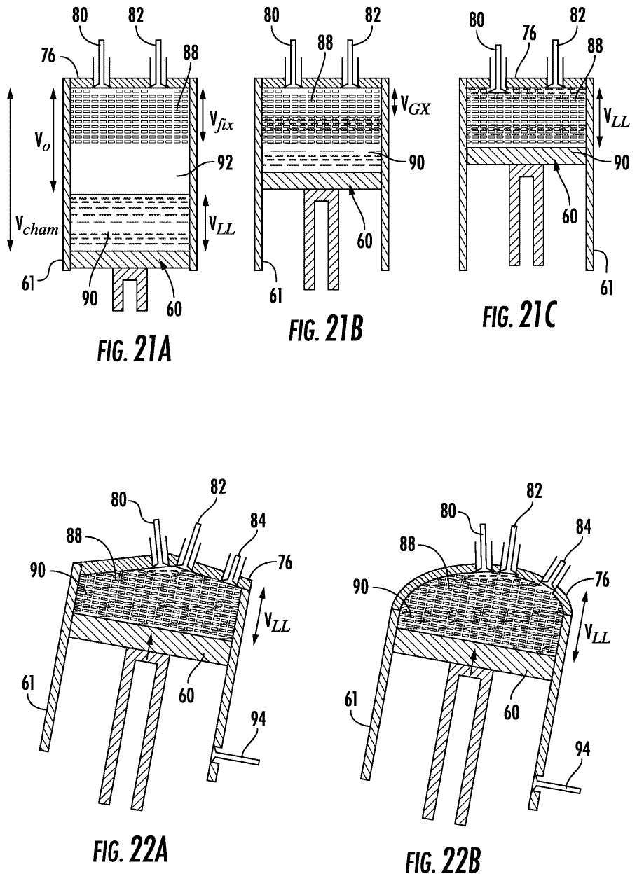

Using the ambient and storage valves along with the piston motion for a single-stage system, a two-stroke cycle can be used for pulling in and compressing air (energy storage) or for expanding and exhausting air (energy regeneration). Valve operations for a single-stage system are based on the storage valve(s) and ambient valve(s) as shown in FIGS. 19A-B. Piston movement is defined relative to advancement to Top Dead Center and recession to Bottom Dead Center. Top Dead Center (TDC) occurs when the piston is at its maximum upwards advancement (maximum distance from the crankshaft and minimum distance to the cylinder head) so that the chamber gas volume is minimized (ideally no gas is left in the chamber but some dead volume may occur in practice). Bottom Dead Center (BDC) occurs when the piston recession is maximum (minimum distance to the crankshaft and maximum distance from the cylinder head) so that the chamber gas volume is maximized. In addition, the Gas Exchange (GX) piston position is defined to occur just after compression is finished or just before expansion starts. (Examples of a piston 60 in a cylinder 61 moving through positions BDC, GX, and TDC can be seen in FIGS. 21, 22, 26, and 29.)

In the following, the process for a single-stage system is described based on rated power and rated pressure ratios while neglecting dead air volume aspects. This is then followed by a discussion on operation at reduced pressure ratios, partial fluid power operations, standby fluid power operations, and multi-stage systems.

The valve timing for rated storage operation (based on compression) can include the following four steps, starting when the piston is at TDC and all valves are closed:
1. Open ambient valve(s) then piston recedes to BDC to “draw in” the ambient filtered air
2. Close ambient valve(s) and then piston advances to compress air until it reaches p_{f,com} at GX
3. Open storage valve(s) as piston continues to advance to “push out” the compressed air
4. Close storage valve(s) just as piston reaches TDC

The total time for all four steps is the cycle time (t_{cycle}). Half of the cycle time (½ t_{cycle}) is for draw in (t_{draw}) while the other half of the total cycle time is for compression (t_{com}) and pushout (tₚᵤₛₕ), i.e.

$$\frac{1}{2} {t}_{cycle} = {t}_{draw} = {t}_{com} + {t}_{push}$$

The four-step process for energy storage then repeats.

For rated conditions, the initial compression volume (V_{i,com}) equals the volume of air in the cylinder just after the ambient valve is closed, which typically occurs at BDC. The final compression volume (V_{f,com}) equals the volume of air in the cylinder just before the storage valve is opened. After compression is complete, the piston is at the GX position and the storage valve is opened to initiate push-out. During push-out, the piston continues to reduce the chamber volume in order push the compressed air into storage. As such, push-out starts at the GX position and will stop once the outlet valve is closed, which typically occurs at TDC.

The valve timing for rated regeneration operation (based on expansion) can include the following four steps, starting when the piston is at TDC and all valves are closed:
1. Open storage valve(s) and then piston recedes to “fill in” compressed air until it reaches GX
2. Close storage valve(s) and then piston recedes to BDC to expand the air to pₒ
3. Open ambient valve(s) and then piston advances to “exhaust out” expanded air
4. Close ambient valve(s) just as piston reaches TDC
   Half of the total cycle time includes the time for both fill in (t_{fill}) and for expansion (tₑₓₚ) while the other half of the total cycle time is for exhaust out (tₑₓₕ), i.e.

$$\frac{1}{2} {t}_{cycle} = {t}_{fill} + {t}_{exp} = {t}_{exh}$$

The four-step process for energy regeneration then repeats.

For rated conditions, the initial expansion volume (V_{i,exp}) equals the volume of air in the cylinder just as the storage valve is closed as the piston reaches the GX position. After that the gas is expanded until the piston reaches BDC, where it reaches final expansion volume (V_{f,exp}) and the ambient valve is opened (expansion is complete). The piston then moves upwards to exhaust-out the expanded air. This exhausting will stop once the ambient valve is closed, which typically occurs at the minimum chamber volume, i.e. at TDC.

While the compression and expansion processes are qualitatively just the reverse of each other, there are quantitative differences between these two cases. For example, round-trip pressure losses associated with transferring to and from storage will generally cause p_{i,exp}<pₛₜₒᵣₑ<p_{f,com}. In addition, round-trip pressure losses associated with transferring to and from the ambient will generally cause p_{f,exp}>pₒ>p_{i,com}. Therefore, the expansion ratio will generally be less than the compression ratio (ER<CR). This can be accommodated by allowing the storage valve during fill-in to stay open longer and/or opening the ambient valve for expansion sooner (before the piston reaches BDC).

Controlled valving can also allow change in the pressure ratios (PR_{com} and PRₑₓₚ) as well as changes in the cycle-averaged volumetric flow rate (Q) for partial power conditions (relative to the rated power conditions). During compression (for an energy storage operation), the storage valve can be adjusted to open sooner (before the rated portion of the compression stroke is complete) to reduce CR and PR_{com} while keeping the flow rate fixed for a given cycle time. Another option is to adjust the ambient valve to stay open later (after the rated compression stroke starts) to reduce the initial compression volume and thereby also reduce the compression pressure ratio. Notably, such a delay in the timing of the ambient valve reduces the volumetric rate for a given cycle time. Similarly, during expansion (for regeneration operation), the ER and PRₑₓₚ can be reduced by delaying the closing of the storage valve and/or opening the ambient valve sooner. Notably, opening the ambient valve sooner reduces the volumetric rate as compared to delaying the closing of the storage valve.

Whether or not the pressure ratio should be varied may depend on whether the compressed air storage tank is “isobaric” or “isochoric”. For an isochoric pressure storage chamber, gas volume is nearly constant so the storage pressure (pₛₜₒᵣₑ) will increase as compressed air is being added and decrease as it is being extracted. As such, an isochoric chamber may be more efficiently charged and discharged with a variable PR_{com} and PRₑₓₚ, which can be accomplished by adjusting the valve timing, as discussed above. For an isobaric pressure storage chamber, the storage pressure (pₛₜₒᵣₑ) is approximately constant as compressed air is being added and extracted. As such, an isobaric storage chamber is best matched with nearly constant compressor and expander pressure ratios (PR_{com} and PRₑₓₚ). Therefore, changes in power with isobaric system should ideally be accomplished without reducing the pressure ratios.

An option to reduce power without reducing the pressure ratios is to employ cylinder deactivation using multiple cylinders and valving control. For example, an eight-cylinder system can have four of its cylinders deactivated so that the remaining four active cylinders provide half the fluid power of rated conditions. During deactivation, the pistons can continue to move to ensure dynamic balancing with other pistons. However, the valves can be controlled so that they do not provide significant fluid power. This deactivation can be accomplished by leaving the ambient valve(s) always open and the storage valve(s) always closed so that the air in these cylinders simply moves to and from the ambient air. In this way, there is negligible compression/expansion for a deactivated cylinder and the power consumption of the deactivated cylinder is minimized. Another option for deactivation is to keep both the ambient valve(s) and storage valve(s) always closed so that the air in these cylinders acts like a pneumatic spring. To minimize the losses for this option, the air inside the cylinder can be set at vacuum (below ambient pressure) conditions, just before deactivation. Vacuum conditions for compression can be accomplished by opening the ambient valve for only a short time after the piston reaches TDC so that only a small volume of ambient air flows in before the cylinder is sealed.

And when neither storage nor regeneration operation is desired, the fluid power system can be set on standby by deactivating all the cylinders. This full deactivation for compression may be appropriate if the storage system is already completely charged (full) while full deactivation for expansion may be appropriate if the storage system the storage system is already completely discharged (empty). In such standby conditions (neither storage nor regeneration) with the pistons still moving, deactivation can be achieved using valve timing as discussed above. Another option for standby conditions (neither storage nor regeneration) is to use a clutch to allow the fluid power system shaft to decouple and be stationary while the rotor crankshaft is rotating. However, adding a clutch may be costly and complex given the large torques associated with wind turbines rotors. As such, performance and cost must both be considered when deciding whether to include a clutch system.

And while FIGS. 15-20 indicate a single-stage compression/expansion system, this same concept can be extended to include multiple-stage compression/expansion system, e.g. a two-stage system or a three-stage system. For a multiple-stage system, stage valves and flow lines are needed to connect the stages. For the example of a two-stage system, the storage valve is replaced with a stage valve for the first stage while the ambient valve is replaced with a stage valve for the second stage.

For compression with a multiple-stage system, the first-stage compressor still has ambient valve(s) but instead of a storage valve, it has a first-stage outlet valve to send higher pressure air in a flow line connected to the second-stage inlet valve and so on to further stages at higher pressures. Similarly for expansion, the first-stage expander still has ambient valve(s) but instead of a storage valve, it has a first-stage inlet valve to pull in higher pressure air from a flow line connected to the second-stage outlet valve and so on to further stages at higher pressures. An advantage of multiple stages is that the first-stage cylinder would be exposed lower pressures, which reduces the structural design requirements and reduces sealing issues.

Furthermore, the connecting flow paths between stages can be opportunities for heat transfer to help promote near isothermal fluid power. For example, the flow lines can have external features or air or liquid-colling and can be filled with a porous mesh with a large mass for high thermal capacity and small pore sizes for fast heat transfer to promote heat transfer to the external surface. In addition, the flow path between two stages can include an interstage settling chamber to reduce pressure unsteadiness and increase heat transfer. Ideally, this interstage settling chamber volume would be much larger than the total displacement volume of the low-pressure stage. The pressurized interstage settling chamber can make use of all or part of the tower shell to enclose this chamber volume and the settling chamber can internally include a porous mesh with a large mass for high thermal capacity and small pore sizes for fast heat transfer. The interstage settling chamber volume can also include a recirculating heat transfer liquid to enhance thermal capacity and mass transfer, e.g. the air flow can be released below the liquid layer so that the air bubbles through the liquid.

However, multiple stages also add system complexity and maintenance issues. As such, performance and cost must both be considered when deciding the ideal number of stages.

### 2.5 Heat Transfer for Near-Isothermal Compression and Expansion

As noted above, near-isothermal conditions are needed for high round-trip efficiency in fluid power energy storage and regeneration. To achieve this, heat transfer to and from the ambient environment can be used during gas compression and expansion so that the gas temperature does not change significantly. Herein, the heat transfer can be accomplished by design of the cylinder walls themselves (Section 2.5.1) as well as by design of a system inside the cylinder volumes using the novel Liquid Layer And Meshes with Mechanical Piston (LLAMMP) approach. The LLAMMP approach is designed to increase internal heat transfer by allowing submersible internal heat exchanger elements and cycle-based heat exchanger liquid within the cylinder, while employing the simplicity and efficiency of conventional piston motion. The baseline LLAMMP approach is based on a fixed porous region inside the cylinder volume (see Section 2.5.2) but may be augmented with a collapsible porous region (see Section 2.5.3) and/or a spray-based region (see Section 2.5.4).

### 2.5.1 Cylinder Wall Heat Transfer

Significant heat transfer can be accomplished by using cylinder walls (cylinder sidewalls, cylinder head, and the piston) that are made of materials with high thermal conductivity and relatively low cost, e.g. aluminium and steel. This conductivity facilitates high conduction heat transfer between the internal and external cylinder surfaces.

To also facilitate convective heat transfer between the external cylinder surfaces and the ambient air flowing past the cylinders (via an internal duct as shown in FIG. 18 or via cylinders protruding above the nacelle surface), external surface features, such as protruding fins, can be added on the external cylinder surfaces to increase the air-exposed surface area.

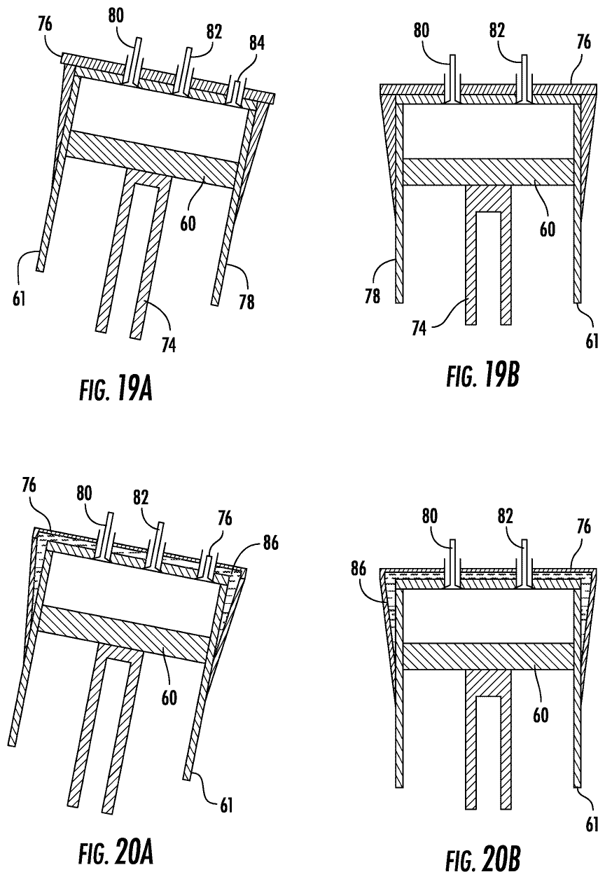

Another convective heat transfer option, as shown in FIGS. 20A-B, incorporates liquid jackets 86 integrated into walls of the cylinder 61. Liquid flowing through passages inside the engine casing can provide high convective heat transfer to cool the cylinder walls during compression and to warm the vessel walls during expansion (making both gas processes more isothermal). After leaving the cylinder jacket 86, the heat transfer liquid can be passed through a radiator (not shown) exposed to ambient conditions (e.g., facing the incoming wind) to return the liquid to near ambient temperatures.

The fluid jacket 86 can employ water as the heat transfer liquid but can include other liquids as well. Some examples include additives or liquid mixtures which can be used to help prevent freezing. Oil or refrigerant liquids may also be used as the heat transfer liquid since they prevent freezing and corrosion while also enhancing lubrication. Preventing freezing is especially important during expansion when the air cools and/or when the ambient air is below the freezing temperature of water.

Before entering the cylinder liquid jacket, the heat transfer liquid can also take advantage of waste heat from the electrical generator. For expansion, where a warmer liquid is beneficial, the liquid can be warmed by the waste heat of the generator and/or gearbox to provide subsequent warming of cylinder walls during gas expansion (to help prevent the gas from cooling too much) and the cooling of this liquid in the jacket during expansion can also be used to help cool the generator and/or gearbox, as is often needed for in large wind turbines. For compression, waste heat of the electrical generator and/or gearbox can also be used to run a chiller (e.g. an absorption cooler) to cool the liquid before entering the cylinder jacket to provide subsequent cooling of cylinder walls during gas compression (to help prevent the gas from warming too much).

2.5.2 LLAMMP with a Fixed Porous Region

The baseline Liquid Layer And Meshes with Mechanical Piston (LLAMMP) approach includes a fixed porous region inside the cylinder volume combined with the heat exchanger liquid in the chamber to provide high heat transfer with the gas. This liquid can be (partially or fully) transferred for each cycle to an external radiator to enhance heat transfer. This liquid also serves to submerse the porous region to allow conventional piston motion for compression and expansion.

The porous structure can be composed of horizontal, vertical, or angled porous layers or other porous geometries. If composed of layers, these can be termed HX (Heat Exchanger) layers. As illustrated in FIGS. 21A-C, the fixed porous region 88 is located at the top of the cylinder volume while the liquid layer 90 generally rests on the bottom of the piston surface 60 for either compression or expansion. In particular, FIG. 21a shows the piston at Bottom Dead Center (BDC), which is just before compression starts or just after expansion ends, where the liquid layer 90 and the fixed porous region 88 do not overlap. FIG. 21b shows the piston 60 at the Gas Exchange (GX) position, which is just after compression is finished or just before expansion starts, where the liquid layer 90 may be partially submerging the fixed porous region 88. FIG. 21c shows the piston 60 at Top Dead Center (TDC), which is just before the compression push-out process starts or just after expansion fill-in process ends, where the liquid layer 90 fills the chamber volume and fully submerges the fixed porous region 88.

For the gas compression stroke, the sequence goes from left to right in FIGS. 21A-C as time advances. In particular, the liquid layer 90 will move upwards to reduce the air volume 92 during compression (from FIG. 19a to FIG. 19b) and push-out the air volume 92 (from FIG. 19b to FIG. 19c). As the air piston moves upwards from BDC to GX, it will cause air 92 to move upwards which will provide convective heat transfer in HX layers of the fixed porous region 88. The heat transfer between the elements HX and the air 92 can prevent significant gas temperature increases and promote more uniform gas temperature within the chamber. As the elements HX are submerged by the liquid 90 during compression and during push-out (as piston moves from GX to TDC), heat transfer between the elements HX and the liquid 92 will occur, which will warm the liquid 92. After pushout is complete and the piston 60 withdraws to bring in fresh air using the ambient valve 82, some or all of the liquid 90 in the chamber can be drained and sent to the entrance of an external heat exchanger system for cooling. An example of a drain valve 94 is shown in FIGS. 22A-B. The warmed liquid that is removed can then be replaced by cooler liquid coming from the exit of the external heat exchanger or from a storage tank as the piston 60 is receding to BDC. This new cooler liquid can be injected from the top or the sides of the cylinders 61. Once the piston 60 reaches BDC, the process can repeat.

For the gas expansion stroke, the sequence in FIGS. 21A-C goes from right to left as time advances. In particular, the liquid layer 90 will move downwards to increase the air volume 92 during fill-in (from FIG. 21c to FIG. 21b) and then expansion (from FIG. 21b to FIG. 21a). As the air 92 moves downwards past the fixed HX elements from FIG. 21b to FIG. 21a, heat transfer between the elements HX and the air 92 can prevent significant gas temperature decreases during expansion. Once the air pressure has reduced to nearly ambient pressure and the expansion process is complete, some or all of the cooled liquid can be drained as the piston is near BDC. The cooled liquid that is removed can then be replaced by warmer liquid (coming from the exit of the external heat exchanger or from a storage tank) as the piston 60 moved upward exhausting the expanded air to the ambient. This new warmer liquid can be injected from the top or the sides of the cylinders 61. Once the piston 60 reaches TDC, the process can repeat.

The external heat exchanger loop for the liquid layer fluid 90 can include a radiator for heat transfer with ambient air or ambient water. For expansion, the waste heat of the electrical generator and/or gearbox can also be used to warm the liquid used for the liquid layer. For compression, this waste heat may be used to run a chiller (e.g. an absorption cooler) to cool the liquid before entering the cylinder as the liquid layer (to help prevent the gas from warming too much).

In the following, some of the key internal volumes are defined based on the four-step processes discussed in Section 2.4 for rated power operation. For FIG. 21a, the air volume at BDC is defined as the ambient volume (Vo) since the pressure in the chamber at this time is nearly equal to the ambient pressure (pₒ). This ambient volume (Vₒ) equals the initial gas volume for compression (V_{i,com}) or the final gas volume for expansion (V_{i,exp}), i.e.

$${V}_{o} = {V}_{i , com} for compression$$

$${V}_{0} = {V}_{f , exp} for expansion$$

As shown in FIG. 21a, the volume of the chamber over which the fixed HX elements are distributed is denoted as V_{fix}, which includes the volume of the HX material as well as the volume of any gas and liquid in this region. The Liquid Layer Volume above the piston surface is denoted as V_{LL}. The initial volume of the chamber for liquid and air combined (V_{cham}) is the sum of the liquid layer and the ambient gas volumes,

$${V}_{cham} ( gas and liquid ) = {V}_{0} ( gas ) + {V}_{LL} ( liquid )$$

If the chamber is cylindrical with a constant cross-sectional area, these internal volumes (V_{cham}, Vₒ, V_{fix}, and V_{LL}) are proportional to the axial lengths within the chamber. However, variable cross-sections can also be employed for the chamber geometry.

FIG. 21b shows the piston at the GX position. For compression, the GX position occurs just after compression is finished and just before gas is transferred to the storage chamber. For expansion, the GX position occurs just before expansion starts and just after gas is transferred from the storage chamber. The air volume at GX is defined as the gas transfer volume (V_{GX}). For a compression stroke, the gas transfer volume equals the final compression gas volume (V_{f,com}). For an expansion stroke, the gas transfer volume equals the initial gas volume (V_{i,exp}). As such, the gas transfer volume can be related to the volumetric Compression Ratio (CR) and Expansion Ratio (ER) as

$${V}_{GX} = {V}_{f , com} = {V}_{i , com} / CR for compression$$

$${V}_{GX} = {V}_{i , exp} = {V}_{f , exp} / ER for expansion$$

For both compression and expansion, some of the internal HX elements will be submerged at the GX position if V_{fix}>V_{GX}. This partial submergence of the porous region reduces the amount of surface area for air-side heat transfer, which reduces the available thermal capacity needed to keep near-isothermal conditions. To minimize the loss of heat exchanger surface area due to submergence when the piston is at or just below the GX position, the porous layers concentration of surface area per volume should be higher near the top of the cylinder. This higher concentration can be in the form of finer mesh sizes and/or higher density of mesh layers.

FIG. 21c shows the piston at TDC just after pushout ends for compression or just before fill-in starts for expansion. At this time, there is ideally no air volume and only the liquid layer fills the chamber. However, there may be some dead air volume due to valve clearance. Dead air volume is problematic since it both reduces the rated displacement volume and leads to power losses. This dead air volume can be minimized by placing valves at the maximum height within the chamber so that the liquid layer prevents air from being located at all lower levels. In addition, the valve timing and liquid layer volume can be adjusted to minimize the amount of air remaining in the chamber at TDC after push out (for storage operation) or before fill in (for regeneration operation).

To maximize the fixed porous volume (for heat transfer) while ensuring the piston surface does not impact any of the fixed porous elements at or near TDC, the volume of the fixed porous region should be slightly less than the total chamber volume at TDC. As such, the fixed porous region volume is approximately equal to the liquid volume (if the dead air volume is relatively small), i.e.

$${V}_{fix} \approx {V}_{L L}$$

Therefore, increasing V_{fix} for a given Vₒ and given Q (to increase heat transfer area and round-trip thermal efficiency) will generally increase V_{LL} and thus increase in the maximum total chamber volume (Vₒ+V_{LL}), which may increase system costs. Therefore, the optimum ratio of V_{fix}/Vₒ requires a balance of cost vs. efficiency.

Notably, the cylinder head can be shaped to ensure the valves are at the maximum height within the chamber so that dead volume can be minimized. For example, this can include a conical shape or a round shape as shown by the TDC side views in FIG. 22A-B. Such shapes may allow better structural support at high pressure and can also increase the cylinder wall surface area just before compression and just after expansion which is beneficial for wall heat transfer. In addition, the cylinder head can also employ a slanted shape where the valves are again placed at the maximum height within the chamber so that dead volume can be minimized. The cylinder head surface area can also be increased with surface corrugation, fins, and other protruding heat transfer surfaces.

Regardless of the cylinder shape, the Liquid Layer And Meshes with Mechanical Piston (LLAMMP) approach should consider over-pressure and sloshing. Cylinder over-pressure is a well-known potential problem with liquid in reciprocating compressors since it can lead to high pressure spikes (e.g., via water hammer) at or near maximum compression due to the incompressibility of liquid. These pressure spikes can cause damage to the cylinder, the valves, connecting rods, and even the crankshaft. This issue can be addressed with fast-acting precision-control valves combined with the slow-moving piston speeds associated with a direct-drive or a low PGSR compressor/expander. For example, poppet valves with electro-hydraulic actuation can be used to help prevent over-pressure. In addition, an emergency pressure relief valve can be added on the cylinder head as shown in FIGS. 8. Moreover, use of multiple exit valves per cylinder (in case one valve gets stuck or has improper timing) can help ensure that over-pressure does not occur.

Sloshing of the liquid layer in the cylinder volume is another potential problem that can lead to increased dead volume and unwanted ingestion of liquid in the ambient and/or storage flow lines. To minimize sloshing, vertical baffles may be installed in the V_{fix} region to reduce free surface dynamics. In addition, the maximum piston acceleration (a_{pist,max}) should ideally be small relative to gravitational acceleration (g=9.81 m/s²), i.e. a_{pist,max}<<g, to minimize wave motion. As an example, the maximum piston acceleration for reciprocating piston motion can be approximated as

$${a}_{pist , max} \approx 2 {π}^{2} ( 1.3 ) {L}_{stroke} / {( {t}_{cycle} )}^{2}$$

If one then considers, a stroke length of 4 meters and a cycle time of 8 seconds, the maximum piston acceleration is about 1.6 m/s², which approximately satisfies a_{pist,max}<<g. This indicates another important benefit of using a direct-drive or low PGSR compressor/expander system, since it allows relatively low piston accelerations. The cylinder head can also be shaped to ensure that liquid layer acceleration also stays small near TDC.

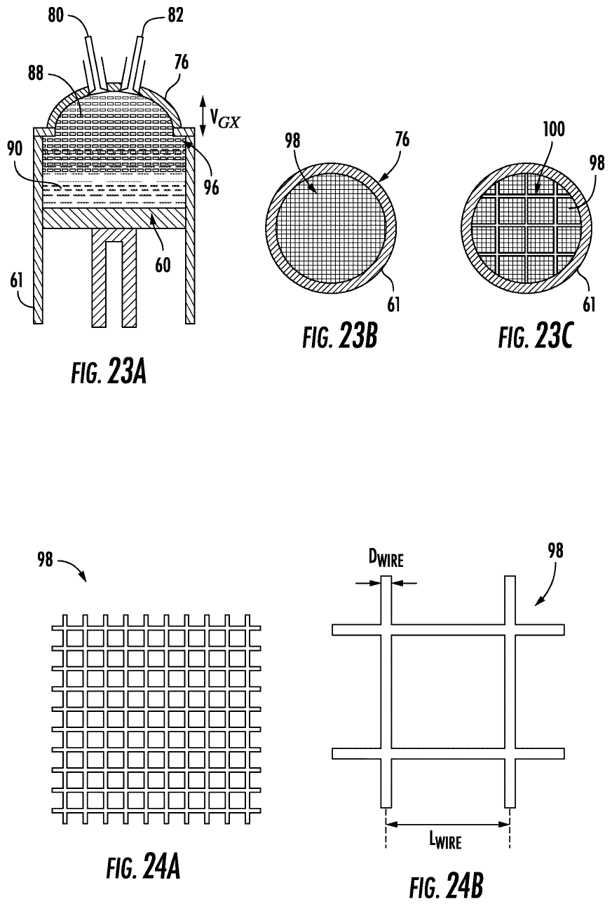

To enhance convective heat transfer during the compression and expansion phases (especially when the piston is just below the GX position and work rates are highest), the cylinder head can also be shaped to increase radial velocities as well as to enhance turbulence by including a squish region 96 as shown in FIG. 23a. The geometry of the squish region 96 introduces a sudden radial velocity that is inward when approaching the end of compression or outward just after the start of expansion. The squish region 96 can be designed so that the induced velocities are maximized when the fluid power levels are highest (near the GX position). The cylinder head 76 can also be corrugated circumferentially, which would promote circumferential velocities, enhance turbulence and increase the surface area, all of which can increase heat transfer.

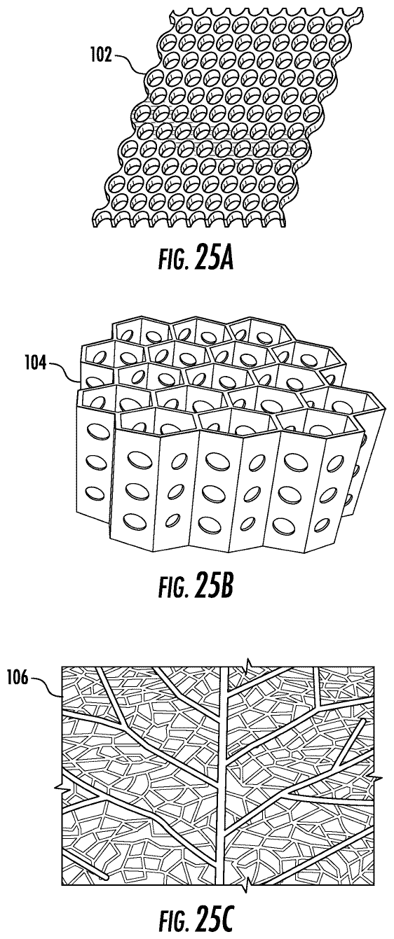

As shown in FIG. 23b, the cross-section within the cylinder head 76 can include heat exchanger HX layers in the form of nearly horizontal wire meshes 98. The meshes 98 can be supported with structural supports 100 as shown in FIG. 23c. The porous layers in FIG. 21-23 can be (flat or woven) wire meshes with a wire diameter d_{wire} and horizontal spacing L_{wire} as shown in FIG. 24. They can also be composed of perforated plates 102, honeycombs 104 and/or bioinspired networks 106 as shown in FIG. 25A-C. Other options for the porous layer geometry include felts, wool-like meshes, and/or solid open-cell foams.

While many geometries are possible, the HX elements should have small enough features to allow rapid thermal response and be plentiful enough to allow a large thermal capacity. A mesh composed of stainless-steel wire with a diameter of 250 microns may have a reasonably fast response time for a compression or expansion process of about 8 seconds. Furthermore, if this mesh includes 40 wires per inch in each horizontal direction and the mesh layers have a vertical spacing of 4 mm and are distributed over a fixed volume region that is four times the gas transfer volume (V_{fix}/V_{GX}=4) for a CR of 40 (Vₒ/V_{GX}=40), this should provide a reasonably large thermal capacity. The combination of rapid thermal response and a large thermal capacity for such a mesh may provide a round-trip thermal efficiency of about 90%. In the following, trade-offs between mesh size and mesh density are discussed.

While decreasing the mesh or pore size will further beneficially reduce the thermal response time, there can be problems if the mesh or pore size is too small. First, finer meshes may be less robust and can therefore be damaged or break, though use of strong materials like steel can help prevent this issue. Second, very small pores may become clogged with particles over time, though this clogging can be prevented by carefully filtering all gas and liquids entering the cylinder chamber. Third, very small pores may result in liquid bridging (when water fills the mesh gaps due to surface tensions) that can problematically reduce the amount of mesh surface area exposed to air. This liquid bridging may be reduced with liquid repellent coatings on the mesh elements, e.g., with Teflon-coated stainless-steel screens. Another approach to reduce this liquid bridging is to ensure the mesh layers are sealed at the cylinder walls (e.g. by adding sealing support rings). Such sealing would minimize any air gap between the mesh and cylinder walls, so that the air is axially is forced through the porous regions (instead of going around them) during both compression and expansion. This air forcing can help break up liquid bridges. In addition, evaporation (via electric heating) or vibration of the HX elements can be used to reduce liquid bridging.

While increasing the number of mesh layers will increase the thermal capacity, there can be problems if the mesh density is too high. First, there will be added cost and complexity when increasing the number of meshes. Second, there will be a higher pressure drop across the mesh layers that results in increased lost work (especially when higher viscosity liquids are moving past the meshes). Third, increased mesh density may reduce heat transfer efficiency (Fugmann et al. 2019) and potentially increase the chance of elements contacting, which can lead to reduced heat transfer as well as wear and erosion of the mesh surfaces.

An alternative to increasing the number of mesh layers it to employ variable spacing since layers that are more likely to be submerged can be less effective. Note that the mesh layers that are submerged do not provide heat transfer to the air and that many of the mesh layers may be submerged when the piston is at the GX position (FIG. 21b). Since the fluid power levels are generally highest when the piston is just below this position (near the end of compression or near the start of expansion), it will generally be preferable to minimize the number of mesh layers that are submerged. This can be accomplished by having the mesh (or porous) layers more closely spaced in the gas transfer volume (V_{GX}) than in the rest of the fixed mesh volume, i.e. using smaller vertical spacing of the meshes near the top of the V_{fix} region and larger spacing near the bottom of the V_{fix} region. This concentration variation increases the mesh thermal capacity at the times when thermal efficiency is most important.

To further increase the heat transfer, the mesh layers can be thermally connected to the larger support elements as shown in FIG. 23c. This enhances the internal thermal capacity within the V_{fix} region. To support this heat transfer from the mesh layers to these supports, these structural supports can be composed of materials with high thermal conductivity (e.g., steel or aluminium). These structural elements can, in turn, be thermally connected to the vessel walls to further enhance the heat transfer between the supports and the vessel walls. In doing so, the effective thermal capacity of the system is increased. The wires themselves can also be directly thermally connected to the vessel walls to increase thermal capacity. For example, aluminium and carbon fibre wires have high mechanical robustness and can have very high thermal conductivity in the wire direction.

Another way to enhance heat transfer is through droplet mass transfer and the associated phase-change energy needed for a liquid to become a vapor. In particular, liquid evaporation during compression will cause phase-change energy to be pulled the gas (which will cool the gas) while any liquid condensation during expansion processes will cause phase-change energy to be sent to the gas (which will warm the gas). While evaporation and condensation processes are hindered at higher pressures, a large amount of liquid surface area can enhance such mass transfer. Since liquid distributed on the large number of heat exchanger elements can be beneficial in this regard, some wetting of liquid on the meshes may be helpful, i.e. liquid bridging can have some benefits.

Water may be a good liquid to use for the liquid layers since water can have significant evaporation when the air temperature increases relative to ambient temperature and significant condensation when the air temperature decreases relative to ambient temperature. Adding ethanol or other volatile liquids to water can provide even higher mass transfer benefits and also provide a reduced freezing point. However, volatile liquids should be added in small fractions to ensure the combined liquid stays below flammability limits (e.g., ethanol fractions of less than 20% in water may be needed to avoid flammability). Another option to have very low freezing points with little risk of flammability is to use a refrigerant liquid or an oil, though such liquids tend to have low vapor pressures (which reduces mass transfer) and high fluid viscosities (which increases pressure losses) and high surface adherence (which increases pore clogging). However, oils and refrigerant liquids prevent corrosion and enhance lubrication (to reduce friction).

2.5.3 LLAMMP with a Collapsible Porous Region

To further increase the thermal mass loading (to improve thermal efficiency) without increasing the liquid layer volume (to avoid increasing the cylinder volume), one option is to distribute additional HX elements in the chamber using axially-collapsible HX elements 108 as shown in FIG. 26A-C. As shown in FIG. 26a, fixed HX porous elements 88 are still placed near the top volume of the cylinder 61 (in V_{fix}) but axially-collapsible elements 108 can also be distributed in a collapsible volume region (V_{col}), which represents some or all of the remaining air regions in the cylinder 61. And while the fixed porous volume remains constant, the collapsible region volume (V_{col}) would be collapsed to its minimum volume when piston 60 is at TDC (FIG. 12c). At TDC, the combination of the collapsible HX volume and the fixed mesh volume (V_{col}+V_{fix}) should be slightly less than the liquid layer volume (V_{LL}), as shown in FIG. 26c. To minimize submerged HX elements, it may be beneficial to have collapsible region volume at its minimum volume when the piston 60 is at the GX position (FIG. 26b). In this case, the collapsible volume could vary as follows:

$${V}_{col} \approx {V}_{o} - {V}_{fix} when piston is at BDC$$

$${V}_{col} \approx {V}_{L L} - {V}_{fix} when piston is at GX$$

$${V}_{col} \approx {V}_{L L} - {V}_{fix} when piston is at TDC$$

In this way, the collapsible elements 108 are fully compressed when the piston 60 is in between GX and TDC and are fully expanded and distributed when the piston 60 is at BDC. The latter aspect allows the HX material to be more fully distributed for more of the process time, which can improve the overall thermal efficiency.

To ensure the HX elements are ideally designed and closely concentrated when the fluid power levels are the highest (i.e. when the piston is near the GX position), it may also be ideal to set the fixed porous volume to equal the GX gas volume,

$${V}_{fix} \approx {V}_{G X}$$

This setting is conceptually shown in FIGS. 26a and 26b.

The collapsible elements 108 can be connected to surfaces in the cylinder chamber. At the top of the chamber, the collapsible elements 108 can be connected to the top of the cylinder 61 and/or the bottom of the fixed HX region. At the bottom of the chamber, these layers can be connected to the piston surface or to a flotation element on the top of the liquid surface. In addition, the collapsible elements layers 108 can also be designed to be buoyant, e.g. made to be hollow and/or with very low-density material (such as polypropylene) and/or connected to sealing/support rings that are buoyant, e.g. hollow. This buoyancy would help keep the porous layers above the liquid surface for as long as possible and help the collapsible region volume reach its minimum volume when piston is at the GX position (FIG. 26b).

There are various approaches to make the HX elements 108 vertically collapsible. One is to use a flexible material such as a sponge or foam that can be compressed. However, such flexible porous surfaces often have a limited compression ratio (ratio of maximum height to minimum height) and may be subject to degradation effects when exposed to many cycles (Gong et al. 2005). Robustness is important for the collapsible HX elements 108 as they will generally experience a very large number of cycles. For example, cycling 10 times a minute during operation and operating 50% of the time, corresponds to about 2.6 million cycles per year. Furthermore, wind turbines are often expected to be in service for more than 20 years, so the total number of cycles of the collapsible elements could be more than 50 million.

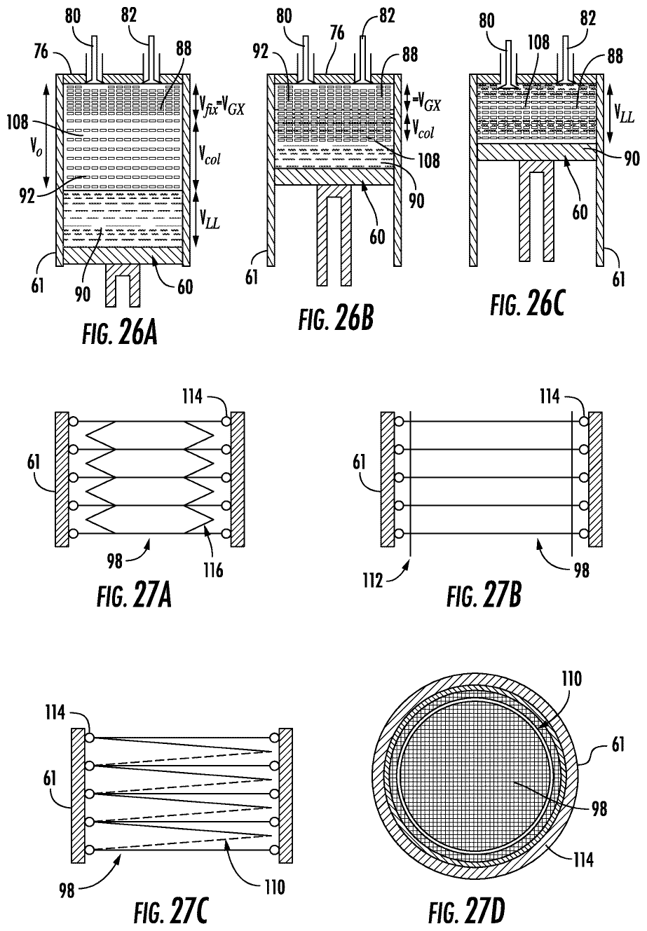

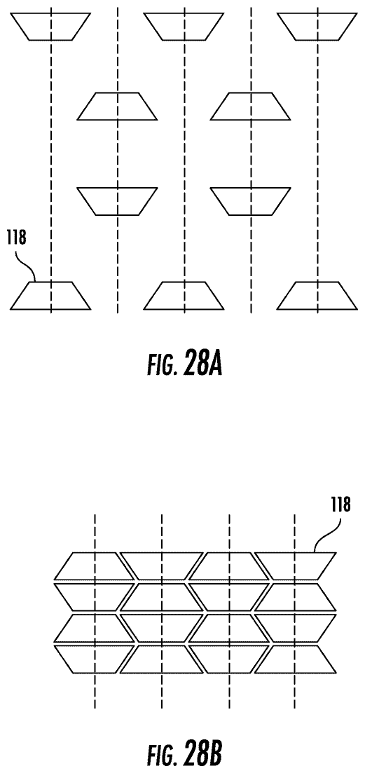

A more robust approach may be to use solid porous disk-like layers as shown in FIG. 26A, which are distributed over the part of the cylinder chamber where the inner diameter is constant. The outer disk diameter would nearly coincide with the chamber inner diameter and the layers would be approximately horizontal but could be angled to accommodate cylinder tilt. These porous layers can then be connected to each other in an axial direction and designed such that the layer spacing varies with piston motion. Example options for these layer connections are shown in FIGS. 27A-C based on connections with bellows (FIG. 27a), with cables (FIG. 27b), and with spiral coils (FIG. 27c). The connections can be accomplished with attachment points on each layer.

FIG. 27A shows a cylinder 61 having the porous layers 98 arranged therein with one or more bellow elements 116 extending through the porous layers 98 in an axial direction relative to the cylinder 61. The bellow 116 is attached to each of the porous layers 98 and is configured to compress and expand as the piston 60 moves through the various positions BDC, GX, TDC, much like the spring embodiment of FIG. 27c.

The spiral coil geometry of FIG. 27c is similar to a SLINKY toy. This toy allows a very large range of axial lengths (fully extended length can be more than 60 times longer than the fully collapsed length) and a spring-like behaviour which promotes the coil to collapse. Using such a helical coil 110 to connect the porous layers 98 would allow the layers to be widely extended when the piston 60 is at BDC and to promote a collapsed state of the layers when the piston position is near GX and TDC. This spring-like behaviour can also help support the porous layers 98 and prevent them from sagging downwards by their weight. When using such helical coils 110, each porous layer 98 can be axially spaced at a distance corresponding to one or more coils (a full circle of the spring material). If spaced based on a single coil, the porous layer thickness can be set approximately equal to or less than the coil thickness so the height of the fully-collapsed layers can correspond approximately to the height of the fully-collapsed coil. In addition to the single coil concept shown in FIG. 27c, multiple smaller springs can also be used to axially support the porous layers 98, where each coil can effectively act like a cable 112 as in FIG. 27b, but with the additional advantage of spring-like behaviour to promote a collapsed state when the piston position is near GX and TDC. Notably, the porous layers 98 may require some aerodynamic sealing and horizontal alignment near the cylinder walls. This can be achieved by adding an edge sealing ring 114, e.g., one made of Teflon or other surface that will allow ease of sliding as shown in FIG. 27d.

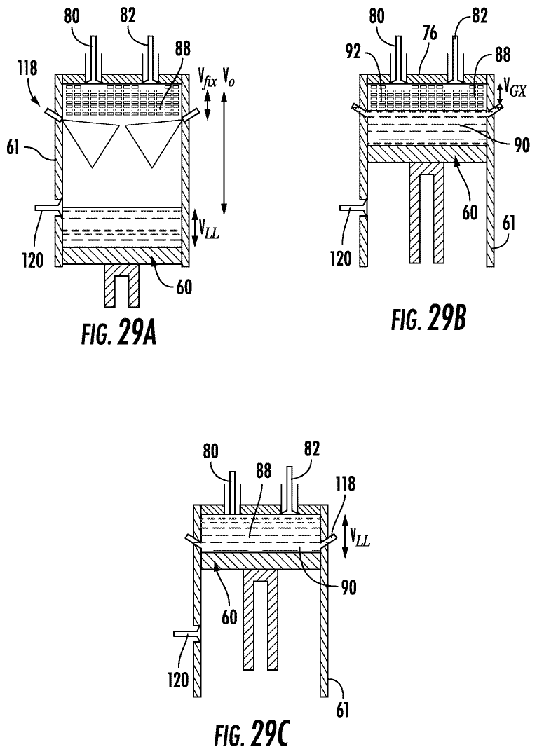

As also shown in FIG. 27d, the porous layer 98 for the collapsible volume can be composed of a wire mesh, as illustrated and discussed with reference to FIGS. 24A-B. The mesh layers can also be composed of the other porous HX geometries, such as those shown in FIGS. 25A-C. In addition, the porous layers can include stackable mating plates 118 connected axially by cables or the like, as shown in FIGS. 28A-B. Therein, the plates 118 can be seen in an expanded configuration, for example when the piston 60 is at BDC, and in a collapsed state, for example when the piston 60 is at TDC. Still in other embodiments, the collapsible volume can be formed of additional materials and structures, such as felts, wool-like meshes, and/or solid open-cell foams.

5.5.4 LLAMMP with a Spray Region

To minimize or avoid the complexity of the moving parts associated with a collapsible system while still having widely distributed heat transfer when the piston is near BDC, another option is to use a spray-based system to inject droplets in the lower part of the chamber. An example combination of a fixed HX system with a lower spray-based system is shown in FIGS. 29A-C. Such a combination may be advantageous since sprays may be good for covering large volumes at low pressures (such as Vₒ) while a fixed porous region may be good at providing high thermal capacity loading in a focused region at high pressures (such as V_{GX}). By adding sprays for heat transfer, the size of the fixed porous region may be reduced as shown in FIG. 29 compared to FIG. 21. Reducing V_{fix} in this way, allows V_{LL} to be reduced, which in turn can reduce the size of the initial chamber volume (V_{cham}=Vₒ+V_{LL}) which may help reduce costs. Spraying followed by draining can also be used to help circulate liquid layer fluid between the chamber and an external heat exchanger loop. Note that the spray augmentation concept (as shown in FIG. 29) can be adapted to include cylinder tilt, pressure relief valves, and various cylinder head shapes (as shown in FIGS. 22-23).

FIGS. 29A-C show an exemplary embodiment in which a cylinder 61 includes spray nozzles 118 located just below the fixed porous region 88 in order to maximize coverage during spraying. Generally, the sprays should ideally be directed away from the porous regions 88 to avoid liquid bridging, and directed away from the sidewalls of the interior of the cylinder 61 to avoid losing droplets to surface impaction. The sprays need only be activated when there is a significant volume of air 92 below the fixed HX region 88. A spray pressure can be achieved by using the storage pressure as the driver for the liquid spray.

For high thermal efficiency, the droplets in the liquid spray should be small enough to provide a rapid heat transfer and plentiful enough to provide a high thermal capacity loading (Simpson et al. 2023a, 2023b). For example, droplets with a mean diameter of about 100 microns or less and a mass loading of unity or more coupled with a fixed porous region with high TCL and low Cr may provide near-isothermal conditions. However, spray-work losses should also be considered when designing the spray systems. For example, hydraulic (liquid-only) nozzles may be preferred as they generally require less pressure work than pneumatic (liquid and air) nozzles for a given droplet size and liquid mass flow rate. In addition, spray work can be reduced by increasing the mean droplet size. Therefore, the ideal droplet size is large enough to avoid significant spray work losses but small enough to have fast thermal response.

In addition to providing thermal load capacity, a spray-based system can enhance heat transfer through mass transfer and the associated phase-change energy. In particular, droplet evaporation during compression will cause phase-change energy to be pulled from the gas (which will cool the gas) while droplet condensation during expansion processes will cause phase-change energy to be sent to the gas (which will warm the gas). Water may be a good liquid to use for spraying since it can have significant evaporation when the air temperature increases relative to ambient temperature and significant condensation when the air temperature decreases relative to ambient temperature. Adding ethanol or other volatile liquids to water can provide even higher mass transfer benefits and can also provide a reduced freezing point. However, volatile liquids should be added in small fractions to ensure the combined liquid stays below flammability limits. Another option to have very low freezing points with little risk of flammability is to use a refrigerant liquid, though such liquids tend to decrease the vapor pressure (which reduces mass transfer) and increases the fluid viscosity (which increases spray work losses). A low-viscosity oil may also be used for spraying since oils prevent freezing and corrosion while also enhancing lubrication.

Another strategy to improve thermal efficiency is to adjust the temperature of the incoming air or liquid before being introduced into the cylinder chamber. For storage operation, the incoming ambient air or liquid for spray could be cooled by passing one or both of the fluids through a low temperature region (e.g., a chiller) and/or by droplet evaporation. For regeneration operation, the high-pressure storage air or liquid can be heated by passing one or both of the fluids through a high-temperature region (e.g. receiving the waste heat from the generator and/or gearbox) before being introduced into the chamber.

Since sprayed droplets will collect in the liquid layer, the liquid layer volume in the cylinder will increase during the spray process shown in FIG. 29A. To remove this excess liquid before the next spray cycle, the liquid pool could be drained using a drain 120 disposed near the bottom of the bottom of the cylinder 61, above the position of the piston 60 at BDC. The drain 120 could be activated when the piston is near BDC. The drain 120 would then be closed when the piston 60 is at GX and TDC. For steady conditions, the volume of liquid that is drained for one cycle will be equal to the volume that is sprayed during one cycle. The drained fluid can then be sent to an external exchanger system, e.g. a radiator that allows heat transfer with the ambient air, before being sent to the cylinder for spraying or be sent to a storage chamber to be later used for spraying. This external heat exchanger can serve to cool the liquid for compression operation or serve to warm the liquid for expansion operation.

To avoid the complexities of a drain valve for cyclic operation, another option is to let any excess liquid leave the chamber through one or more of the cylinder head valves. For example, excess liquid after compression can be sent to the pressurized storage chamber, and then this high-pressure liquid can then later be reinjected as spray. This approach recovers some of the work used to pushout liquid into the storage chamber. After an expansion, the excess liquid can be sent to a non-pressurized reservoir and then later pumped in the chamber as a spray.

Various embodiments of the present invention are described herein with reference to the related drawings. Alternative embodiments can be devised without departing from the scope of this invention. It is noted that various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship.

The term “exemplary” is used herein to mean “serving as an example, instance, or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. Terms such as “connected to”, “affixed to”, etc., can include both an indirect “connection” and a direct “connection.”

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### REFERENCES

The following patents, applications and publications as listed below and throughout this document are hereby incorporated by reference in their entirety herein, and which are not admitted to be prior art with respect to the present disclosure by inclusion in this section.
Cheng and Choobineh (2019) Wind energy to compressed fluid conversion and energy system. US Patent US 2019/0017494 A1 by for Board of Regents for Nebraska.
Dutta, R., Wang, F., Bohlmann, B.F. & Stelson, K. A. (2104) Analysis of Short-Term Energy Storage for Midsize Hydrostatic Wind Turbine. Journal of Dynamic Systems, Measurement, and Control, Vo. 136, 011007.
Simpson J and Loth, E. (2022) Super-rated operational concept for increased wind turbine power with energy storage. Energy Conversion and Management: X, 14, 100194.
Tian, D., Tang, S., Tao, L., Li, B. & Wu, X. (2023) Peak shaving strategy for load reduction of wind turbines based on model predictive control, Energy Reports, Volume 9, pp 338-349.
Fugmann, H., Scnabel, L, Fronhapfel, B. 2019) Heat transfer and pressure drop correlations for laminar flow in an in-line and staggered array of circular cylinders. Numerical Heat Transfer, Part A: Applications, 75:1, 1-20.
Gong, L., S. Kyriakides, W.-Y. Jang (2005) Compressive response of open-cell foams. Part I: Morphology and elastic properties. International Journal of Solids and Structures 42, pp. 1355-1379
Isshiki, S., A. Sakano; I. Ushiyama; N. Isshiki (1996) Measurement on Nusselt number of regenerator wire meshes by cylindrical probe, Proceedings of the 31st Intersociety Energy Conversion Engineering Conference, IECEC 96.
Simpson, J., Qin, C, and Loth, E. (2023a) Spray-cooled compression: Theory and simulation. Applied Thermal Engineering, Volume 229, 5 Jul. 2023, 120619.
Simpson, J., Qin, C, and Loth, E. (2023b) Predicted roundtrip efficiency for compressed air energy storage using spray-based heat transfer. Journal of Energy Storage 72, 108461, 3.

LISTING OF REFERENCE NUMERALS:

| R1 | region 1 |
|---|---|
| R2 | region 2 |
| R2⁺ | region 2⁺ |
| R3 | region 3 |
| R3⁺ | region 3⁺ |
| R3^{cap} | region 3^{cap} |
| R4 | region 4 |
| 10 | conventional wind turbine |
| 12 | tower |
| 14 | nacelle |
| 15 | nacelle bedplate |
| 16 | rotor |
| 18 | electrical cables |
| 20 | access ladders/elevator |
| 22 | tower volume |
| 30 | wind turbine |
| 32 | tower side casing |
| 40 | conventional wind turbine |
| 42 | base |
| 44 | wind turbine |
| 46 | fly wheel |
| 50 | wind turbine |
| 52 | rotor shaft |
| 54 | hub |
| 56 | direct drive electric generator |
| 58 | air compressor/expander |
| 60 | piston |
| 61 | cylinder |
| 62 | crankshaft |
| 64 | gearbox |
| 66 | high speed shaft |
| 68 | high speed electrical generator |
| 70 | air duct |
| 72 | vanes |
| 74 | connecting rod |
| 76 | cylinder head |
| 78 | cylinder casing |
| 80 | storage valve |
| 82 | ambient valve |
| 84 | emergency relief valve |
| 86 | liquid jackets |
| 88 | fixed porous region |
| 90 | liquid layer |
| 92 | air volume |
| 94 | drain volume |
| 96 | squish region |
| 98 | wire mesh layers |
| 100 | structural supports |
| 102 | perforated plates |
| 104 | honeycombs |
| 106 | bio-inspired mesh |
| 108 | axially collapsible elements |
| 110 | helical coil |
| 112 | cable |
| 114 | edge sealing ring |
| 116 | bellow |
| 118 | spray nozzles |
| 120 | drain |

1. A system for flexible wind turbine operation for wind energy storage, comprising:
a wind turbine having a rotor disposed thereon;
a rotor shaft extending from the rotor and rotatable therewith;
an electrical generator disposed in communication with the rotor shaft;
a power generation/regeneration fluid power system, whose shaft is disposed along the rotor shaft or with a constant gear ratio relative to the rotor shaft;
wherein aerodynamic rotation of the rotor shaft rotates the electrical generator to produce generator power (P_{g});
wherein, when the fluid power system is in a power generation mode, aerodynamic rotation of the rotor shaft produces fluid power (P_{f}) at the fluid power system, at least a portion of which is stored as energy in an energy storage; and
wherein, when the fluid power system is in a power regeneration mode, energy is released from the energy storage and converted by the fluid power system to fluid power (P_{f}) that rotates the rotor shaft within the electrical generator.

2. The system of claim 1, wherein:
when the fluid power system is not operating, the electrical generator has a maximum power rating (P_{g,rated}), which can be achieved for wind speeds between a rated wind speed (U_{rated}) and a cut-out wind speed (U_{cut-out}) with a rated rotor speed (ω_{r,rated});
when the fluid power system is in the power generation mode, the rotor power (Pᵣ) produced by the aerodynamic rotation of the rotor is the sum of the generator power (P_{g}) combined with the fluid power (P_{f}), and
when the fluid power system is in the power regeneration mode, the generator power (P_{g}) is the sum of the rotor power (Pᵣ) produced by the aerodynamic rotation of the rotor combined with the regenerated fluid power (P_{f}).

3. The system of claim 2, wherein:
the fluid power system has a maximum power rating (P_{f,rated});
the generator power (P_{g}) can flexibly operate anywhere in the range from 0% and 100% of the maximum generator power rating (P_{g,rated});
the fluid power (P_{f}) can flexibly operate anywhere in the range from 0% and 100% of the maximum fluid power rating (P_{f,rated}).

4. The system of claim 3, wherein:
proportions of rotor power (Pᵣ), fluid power (P_{f}), and generator power (P_{g}) can be adjusted based on available wind energy, grid demand (including generator curtailment), and available storage capacity for flexible operation;
a rotor blade pitch can be controlled to achieve the desired rotor power (Pᵣ);
the fluid power (P_{f}) can vary with shaft speed and by deactivating individual compressor/expanders.

5. The system of claim 3, wherein:
the rotor speed (ωᵣ) is limited to the rated rotor speed (ω_{r,rated}) even if the rotor power exceeds the maximum generator power rating (P_{g,rated});
a rotor thrust (T) is limited to a rated rotor thrust (T_{rated}) even if the rotor power exceeds the maximum generator power rating (P_{g,rated}).

6. The system of claim 3, wherein the fluid power system is composed only of a pneumatic compressor/expander system with no intermediary hydraulic system.

7. The system of claim 1, further comprising a tower having an interior volume and one or more tower side casings disposed on an exterior of the tower, wherein components of the wind turbine that are typically enclosed within the tower are disposed in and/or extend through one or more of the tower side casings, and wherein this allows the energy storage and/or an interstage settling chamber is disposed in at least part of the internal volume of the tower.

8. The system of claim 1, wherein
the fluid power generation/regeneration system for energy storage may be augmented or replaced with a gravitational potential energy storage system;
the fluid power generation/regeneration system for energy storage may be augmented or replaced with a rotational kinetic energy storage system comprising a flywheel disposed in the wind turbine tower or as pail of a base of the wind turbine
the fluid power generation system may be augmented or replaced, a system to produce hydrogen via hydrolysis, and/or a desalination system to produce freshwater from saltwater;

9. The system of claim 4, wherein:
the power generation/regeneration system is a fluid power system comprising an air compressor/expander;
wherein the fluid power system shaft is directly connected to the rotor shaft such that fluid power system shaft and the rotor shaft rotate at the same speed, or the fluid power system shaft is connected to the rotor shaft by a geared mechanism such that the fluid power system shaft and the rotor rotate at different speeds but with a fixed speed ratio;
wherein the electrical generator is directly connected to the rotor shaft such that electrical generator and the rotor shaft rotate at the same speed, or the electrical generator is connected to the rotor shaft or to the fluid power system shaft by a geared mechanism such that the electrical generator and the rotor shaft or fluid power system shaft, respectively, rotate at different speeds;
wherein the air compressor/expander and any associated gearing mechanisms are disposed in a nacelle, and/or within a front frame, and/or adjacent to a generator and/or within a nosecone and/or within a tower;

10. The system of claim 9, wherein an air duct inlet located on the exterior of the nacelle or the nose cone extracts ambient air from a wind stream directed at the wind turbine, and is configured to direct the entrained air over the pistons for convective heat transfer and then to exhaust air to the nacelle exterior and/or to direct the entrained air to be used as intake ambient air for piston compression operation and then to exhaust the outlet ambient air from a piston expansion operation to the nacelle exterior.

11. The system of claim 9, wherein:
at least one stage of the compressor/expander comprises one or a plurality of pistons coupled to a crankshaft whereby rotation of the crankshaft drives the piston or pistons in a reciprocating manner
at least one piston comprises at least one storage valve for directing air compressed within the piston to the energy storage for compressed air energy generation and for receiving air from energy storage to be expanded during energy regeneration;
at least one piston comprises at least one ambient valve for drawing air into the piston from an ambient environment;
each cylinder comprises a cylinder casing, a piston head disposed movably in the cylinder, and a cylinder volume within the cylinder that varies upon movement of the piston head; and
the compressor/expander cylinders may include single-acting or double-acting pistons.

12. The system of claim 11, wherein the cylinder volume contains a liquid volume, a gas volume, and porous heat transfer surfaces.

13. The system of claim 12, wherein the porous heat transfer surfaces are disposed at an upper region of the cylinder volume adjacent to the storage and ambient valves, the porous heat transfer surfaces being configured to allow the gas and liquid to pass therethrough during compression and expansion of the cylinder volume upon movement of the piston head and to provide convective heat transfer between the gas, liquid, and casing of the cylinder, and the ambient environment.

14. The system of claim 12, wherein the porous heat transfer surfaces are horizontal, vertical, or angled porous layers, or other porous geometries and comprise one or more of the following:
fixed heat transfer elements secured immovably within the cylinder volume;
fixed heat transfer support system secured immovably within the cylinder volume to allow high thermal conductivity between the heat transfer elements and the cylinder casing;
movable heat transfer elements that expand and compress within the cylinder volume during movement of the piston head by way of bellows, spring coils, and/or axial cables; and
heat transfer elements formed of wire mesh, perforated plates, honeycomb structures, bio-inspired mesh, or stackable mating plates;
one or a plurality of nozzles disposed in the cylinder volume configured to spray liquid into the gas volume to provided cooling.

15. The system of claim 12, further comprising an emergency pressure relief valve for releasing compressed air from the piston on demand.

16. The system of claim 12, further comprising a liquid jacket disposed on the casing of the cylinder of the piston configured to provide convective heat transfer between the casing and the ambient environment.

17. The system of claim 12, further comprising a drainage valve to remove some or all heat transfer liquid after each cycle or after a change in operation.

18. The system of claim 12, further comprising a liquid supply and valve to add some or all heat transfer liquid after each cycle or after a change in operation.

19. The system of claim 12, wherein the cylinder head is coned, curved, or slanted and the valves are located at a topmost portion of the cylinder head to help reduce dead volume.

20. The system of claim 9, wherein one or more of compressor/expander cylinder casings is disposed within the turbine tower or is part of the tower shell to provide structural support for elevated air pressure and a thermally conductive casing.

21. The system of claim 9, wherein multiple-stage compression/expansion is used.

22. The system of claim 21, wherein an interstage settling chamber is used between stages to reduce pressure fluctuations and provide inter-stage heat transfer.

23. The system of claim 22, where the interstage settling chamber is disposed within the turbine tower where the tower shell provides structural support for elevated air pressures and provides a thermally conductive casing to provide heat transfer to the environment or a interstage settling chamber is dispose in the front frame and/or hub where the structural shell provides structural support for elevated air pressures and provides a thermally conductive casing to provide heat transfer to ducted air flow from the nose cone or to a liquid heat transfer system.

24. The system of claim 4, wherein the fluid power system is composed of a single-stage or multiple-stage centrifugal air compressor coupled with a turbine based on a fixed gearing ratio of one or more.

25. The system of claim 24, wherein some or all the fluid passages between and within the stages are filled with porous mesh material and/or liquid spray to promote heat transfer.

26. The system of claim 12, wherein the fluid power system is used for industrial air compression, instead for a wind turbine energy storage.

27. A system to control tower loads and dynamics wherein liquid, such as water, is placed in part or all of a cylindrically-shaped tower and allowed to slosh back and forth to provide a tuned mass damper and to adjust a natural frequency of the tower, wherein the liquid volume can be adjusted to optimize damping in extreme load conditions.
